(19) United States
(12) Patent Application Publication
(10) Pub. No.: US 2026/0343539 A1
(43) Pub. Date: Oct. 29, 2026

(54) KOFFSET CONFIGURATION AND DELAY INDICATION FOR NARROWBAND PHYSICAL UPLINK SHARED CHANNEL TRANSMISSION IN INTERNET OF THINGS NON-TERRESTRIAL NETWORK TIME DIVISION DUPLEX

(71) Applicant: Sharp Kabushiki Kaisha, Sakai City (JP)

(72) Inventor: Zhanping Yin, Vancouver, WA (US)

(21) Appl. No.: 19/191,837

(22) Filed: Apr. 28, 2025

(51) Int. Cl. H04W 72/1273; H04L 1/1812; H04L 5/14; H04W 72/232

(52) U.S. Cl. CPC H04W 72/1273; H04L 1/1812; H04L 5/14; H04W 72/232

(57) ABSTRACT

A user equipment (UE) configured for operation in an internet of things (IoT) non-terrestrial network (NTN) using time division duplex (TDD) is described. The UE includes receiving circuitry configured to detect a downlink message on a given serving cell, the downlink message being a narrowband physical downlink control channel (NPDCCH) with downlink control information (DCI) format N0, or a narrowband physical downlink shared channel (NPDSCH) scheduled by DCI format N1. The UE also includes transmitting circuitry configured to perform a narrowband physical uplink shared channel (NPUSCH) transmission in a U=8 uplink (UL) subframe timeslot in period m′.

### TECHNICAL FIELD

The present disclosure relates generally to communication systems. More specifically, the present disclosure relates to systems and methods for Koffset configuration and delay indication for Narrowband Physical Uplink Shared Channel (NPUSCH) transmission in Internet of Things (IoT) Non-Terrestrial Network (NTN) Time Division Duplex (TDD).

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility, and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a diagram illustrating an example of a Non-Terrestrial Network (NTN) coverage area;

FIG. 2 is a diagram illustrating an example of a legacy L-band Time Division Duplex (TDD) frame structure;

FIG. 3 is a diagram illustrating an example of a structure for an Internet of Things (IoT) Non-Terrestrial Network (NTN) Time Division Duplex (TDD) cell with downlink (DL) and uplink (UL) timeslots within a 90 millisecond (ms) period;

FIG. 4 is a diagram illustrating an example of synchronization signals in a DL timeslot of an IoT NTN TDD;

FIG. 5 is a diagram illustrating an example of an NPUSCH format for carrying uplink data;

FIG. 6 is a diagram illustrating an example of an NPUSCH format for signaling hybrid automatic repeat request acknowledgment (HARQ-ACK) for Narrowband Physical Downlink Shared Channel (NPDSCH);

FIG. 7 is a table illustrating an example of supported combinations of

$${N}_{sc}^{RU} , {N}_{slots}^{UL} , and {N}_{symb}^{UL}$$

for frame structure type 1;

FIG. 8 is a table illustrating an example of Downlink Control Information (DCI) formats N0 for Narrowband (NB) IoT NPUSCH;

FIG. 9 is a table illustrating an example of k₀ for DCI format N0 for Frequency Division Duplex (FDD);

FIG. 10 is a table illustrating an example of k₀ for DCI format N0 for TDD;

FIG. 11 is a table illustrating an example of DCI format N1 for IoT NPDSCH scheduling and HARQ-ACK feedback;

FIG. 12 is a table illustrating an example of Acknowledgment/Negative Acknowledgment (ACK/NACK) subcarrier and k₀ for NPUSCH with subcarrier spacing Δf=3.75 kHz;

FIG. 13 is a table illustrating an example of ACK/NACK subcarrier and k0 for NPUSCH with subcarrier spacing Δf=15 kHz;

FIG. 14 is a table illustrating an example of allocated subcarriers for NPUSCH with Δf=15 kHz;

FIG. 15 is a diagram illustrating an example of how the subcarrier indication field in DCI format N0 specifies the subcarriers to allocate UL resources for 15 kHz SCS;

FIG. 16 is a table illustrating an example of the unused bit being used together with the 2-bit scheduling delay field to indicate the subframe index in the U=8 timeslot;

FIG. 17 is a table illustrating an example of the most significant bit in the subcarrier indication field being used to indicate the group;

FIG. 18 is a table illustrating an example of ACK/NACK subcarrier and k₀ for NPUSCH with subcarrier spacing Δf=3.75 kHz for IoT NTN TDD;

FIG. 19 is a table illustrating an example of ACK/NACK subcarrier and k₀ for NPUSCH with subcarrier spacing Δf=15 kHz for IoT NTN TDD;

FIG. 20 is a flow diagram illustrating an example of a communication method by an IoT NTN device UE using TDD;

FIG. 21 is a flow diagram illustrating another example of a communication method by an IoT NTN device UE using TDD;

FIG. 22 is a flow diagram illustrating another example of a communication method by an IoT NTN device UE using TDD;

FIG. 23 is a diagram illustrating one implementation of a core network node;

FIG. 24 is a block diagram illustrating one implementation of a base station (eNB) in which the present systems and methods may be implemented;

FIG. 25 is a block diagram illustrating one implementation of a wireless terminal in which the present systems and methods may be implemented;

FIG. 26 illustrates various components that may be utilized in a wireless terminal in which the present systems and methods may be implemented;

FIG. 27 illustrates various components that may be utilized in an eNB in which the present systems and methods may be implemented;

FIG. 28 is a block diagram illustrating one implementation of a wireless terminal in which the present systems and methods may be implemented; and

FIG. 29 is a block diagram illustrating one implementation of a eNB in which the present systems and methods may be implemented.

### DETAILED DESCRIPTION

A user equipment (UE) configured for operation in an internet of things (IoT) non-terrestrial network (NTN) using time division duplex (TDD) is described. The UE includes receiving circuitry configured to detect a downlink message on a given serving cell, the downlink message being a narrowband physical downlink control channel (NPDCCH) with downlink control information (DCI) format N0, or a narrowband physical downlink shared channel (NPDSCH) scheduled by DCI format N1. The UE also includes transmitting circuitry configured to perform a narrowband physical uplink shared channel (NPUSCH) transmission in a U=8 uplink (UL) subframe timeslot in period m′.

In some examples, the downlink message ends in narrowband internet of things (NB-IoT) downlink (DL) subframe index n (0≤n≤7) within a D=8 DL subframe timeslot in period m. The downlink message may schedule a narrowband physical uplink shared channel (NPUSCH) format 1 transmission or a hybrid automatic repeat request acknowledgment (HARQ-ACK) report with NPUSCH format 2 intended for the UE.

In some implementations, m′=m+Koffset when Koffset is configured with a positive integer number. In other implementations, m′=m when Koffset is not configured or set as 0.

An e-NodeB (eNB) configured for operation in an internet of things (IoT) non-terrestrial network (NTN) using time division duplex (TDD) is also described. The eNB includes transmitting circuitry configured to transmit a downlink message on a given serving cell, the downlink message being a narrowband physical downlink control channel (NPDCCH) with downlink control information (DCI) format N0, or a narrowband physical downlink shared channel (NPDSCH) scheduled by DCI format N1. The eNB also includes receiving circuitry configured to receive a narrowband physical uplink shared channel (NPUSCH) transmission in a U=8 uplink (UL) subframe timeslot in period m′.

The transmitting circuitry of the eNB may be further configured to configure a Koffset parameter via radio resource control (RRC) signaling. The Koffset parameter may be used to determine the scheduling delay in a number of IoT NTN TDD periods, wherein each period is 90 milliseconds (ms).

A method performed by a user equipment (UE) configured for operation in an internet of things (IoT) non-terrestrial network (NTN) using time division duplex (TDD) is also described. The method includes detecting a downlink message on a given serving cell, the downlink message being a narrowband physical downlink control channel (NPDCCH) with downlink control information (DCI) format N0, or a narrowband physical downlink shared channel (NPDSCH) scheduled by DCI format N1. The method further includes performing a narrowband physical uplink shared channel (NPUSCH) transmission in a U=8 uplink (UL) subframe timeslot in period m′.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11 and/or 12). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a wireless terminal, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a wireless terminal. However, as the scope of the present disclosure should not be limited to the 3GPP standards, the terms “wireless terminal” and “wireless communication device” may be used interchangeably herein to mean the more general term “wireless communication device.” A wireless terminal may also be more generally referred to as a terminal device.

In 3GPP specifications, a base station is typically referred to as a Node B, an evolved Node B (eNB), a home enhanced or evolved Node B (HeNB) or some other similar terminology. As the scope of the disclosure should not be limited to 3GPP standards, the terms “base station,” “Node B,” “eNB,” “gNB” and/or “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a wireless terminal. It should also be noted that in E-UTRA and E-UTRAN overall description, as used herein, a “cell” may be defined as “combination of downlink and optionally uplink resources.” The linking between the carrier frequency of the downlink (DL) resources and the carrier frequency of the uplink resources may be indicated in the system information transmitted on the downlink resources.

“Configured cells” are those cells of which the wireless terminal is aware and is allowed by an eNB to transmit or receive information. “Configured cell(s)” may be serving cell(s). The wireless terminal may receive system information and perform the required measurements on all configured cells. “Configured cell(s)” for a radio connection may include a primary cell and/or no, one, or more secondary cell(s). “Activated cells” are those configured cells on which the wireless terminal is transmitting and receiving. That is, activated cells are those cells for which the wireless terminal monitors the physical downlink control channel (PDCCH) and in the case of a downlink transmission, those cells for which the wireless terminal decodes a physical downlink shared channel (PDSCH). “Deactivated cells” are those configured cells that the wireless terminal is not monitoring the transmission PDCCH. It should be noted that a “cell” may be described in terms of differing dimensions. For example, a “cell” may have temporal, spatial (e.g., geographical) and frequency characteristics.

Fifth generation (5G) cellular communications (also referred to as “New Radio,” “New Radio Access Technology” or “NR” by 3GPP) envisions the use of time, frequency and/or space resources to allow for enhanced mobile broadband (eMBB) communication and ultra-reliable low-latency communication (URLLC) services, as well as massive machine type communication (MMTC) like services. To meet a latency target and high reliability, mini-slot-based repetitions with flexible transmission occasions may be supported. Approaches for applying mini-slot-based repetitions are described herein. A new radio (NR) base station may be referred to as a gNB. A gNB may also be more generally referred to as a base station device.

One important objective of 5G is to enable connected industries. 5G connectivity can serve as a catalyst for the next wave of industrial transformation and digitalization, which improve flexibility, enhance productivity and efficiency, reduce maintenance cost, and improve operational safety. Devices in such environments may include, for example, pressure sensors, humidity sensors, thermometers, motion sensors, accelerometers, actuators, etc. It is desirable to connect these sensors and actuators to 5G networks and core. The massive industrial wireless sensor network (IWSN) use cases and requirements include not only URLLC services with very high requirements, but also relatively low-end services with the requirement of small device form factors, and/or being completely wireless with a battery life of several years. The requirements for these services that are higher than low power wide area (LPWA) (e.g., LTE-MTC and/or Narrowband Internet of Things (LTE-M/NB-IoT)) but lower than URLLC and eMBB.

A non-terrestrial network (NTN) refers to a network, or segment of networks using radio frequency (RF) resources onboard a satellite (or UAS platform). Non-Terrestrial Network typically features the following elements: one or several sat-gateways that connect the Non-Terrestrial Network to a public data network. For example, a Geostationary Earth Orbiting (GEO) satellite is fed by one or several sat-gateways which are deployed across the satellite targeted coverage (e.g., regional or even continental coverage). It may be assumed that wireless terminals in a cell are served by only one sat-gateway. A Non-GEO satellite served successively by one or several sat-gateways at a time. The system ensures service and feeder link continuity between the successive serving sat-gateways with sufficient time duration to proceed with mobility anchoring and hand-over.

Additionally, Non-Terrestrial Network typically features the following elements: a Feeder link or radio link between a sat-gateway and the satellite (or Unmanned Aircraft System (UAS) platform), a service link or radio link between the wireless terminal and the satellite (or UAS platform).

Additionally, a Non-Terrestrial Network typically features the following elements: a satellite (or UAS platform) which may implement either a transparent or a regenerative (with onboard processing) payload. The satellite (or Unmanned Aircraft System (UAS) platform) may generate several beams over a given service area bounded by its field of view. The footprints of the beams are typically of elliptic shape. The field of view of a satellite (or UAS platform) depends on the onboard antenna diagram and minimum elevation angle. For a transparent payload, radio frequency filtering, frequency conversion and amplification may be applied. Hence, the waveform signal repeated by the payload is un-changed. For a regenerative payload, radio frequency filtering, frequency conversion and amplification as well as demodulation/decoding, switch and/or routing, coding/modulation may be applied. This is effectively equivalent to having all or part of base station functions (e.g., gNB) onboard the satellite (or UAS platform).

Additionally, Non-Terrestrial Network may optionally feature the following elements: Inter-satellite links (ISL) optionally in case of a constellation of satellites. This will require regenerative payloads onboard the satellites. ISL may operate in RF frequency or optical bands.

Additionally, Non-Terrestrial Network typically features the following elements: User Equipment (UE) may be served by the satellite (or UAS platform) within the targeted service area.

There may be different types of satellites (or UAS platforms): Low-Earth Orbit (LEO) satellite, Medium-Earth Orbit (MEO) satellite, Geostationary Earth Orbit (GEO) satellite, UAS platform (including High-Altitude Platform Station (HAPS) and High Elliptical Orbit (HEO) satellite). Detailed descriptions are shown in Table 1.

TABLE 1

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms of | | |
| UAS platform | 8-50 km (20 km | | elevation/azimuth with | 5-200 | km |
| (including HAPS) | for HAPS) | | respect to a given earth | | |
| | | | point | | |
| High Elliptical Orbit | 400-50000 | km | Elliptical around the earth | 200-3500 | km |
| (HEO) satellite | | | | | |

Typically, GEO satellites and UAS are used to provide continental, regional or local service. A constellation of LEO and MEO may be used to provide services in both Northern and Southern hemispheres. In some cases, the constellation can even provide global coverage including polar regions. For the later, this requires appropriate orbit inclination, sufficient beams generated and inter-satellite links.

Non-terrestrial networks may provide access to wireless terminal in six reference scenarios including: Circular orbiting and notional station keeping platforms, highest round trip delay (RTD) constraint, highest Doppler constraint, a transparent and a regenerative payload, one ISL case and one without ISL (Regenerative payload is mandatory in the case of inter-satellite links), fixed or steerable beams resulting respectively in moving or fixed beam foot print on the ground.

The systems and methods described herein may be used to address the needs suggested by the following:

IoT NTN TDD is designed to use legacy Iridium bands for NB-IoT operations with backward compatibility of legacy TDD patterns.

The IoT NTN TDD system will support a 90 ms periodicity with 8 continuous downlink subframes (D=8) in a downlink timeslot and 8 continuous uplink subframes (U=8) in an uplink timeslot. The distance between the downlink (DL) timeslot and uplink (UL) timeslot is fixed with a value of 48-50 ms. The uplink transmission alignment is achieved by the adjustment of common timing advance (TA) in the cell with eNB implementation and no specification impact.

DCI format N0 is used for NPUSCH scheduling. Among the DCI parameters, a delay parameter is used to determine the delay of a NPUSCH transmission after the completion of a Narrowband Physical Downlink Control Channel (NPDCCH) transmission and DCI indication.

DCI format N1 is used for Narrowband Physical Downlink Shared Channel (NPDSCH) scheduling. Among the DCI parameters, a HARQ-ACK resource indication parameter is used to determine the resource and the timing for HARQ-ACK reporting on a NPUSCH format 2 transmission after the completion of NPDSCH transmission.

In both cases, the timing of the NPUSCH transmission includes:
A Koffset is used to indicate a fixed delay offset value to compensate for the RTT.
A k0 parameter is used to indicate the delay in a number of subframes in a fixed set of values.

In IoT NTN TDD only a single D=8 subframe and U=8 subframe are available in a 90 ms period. The eNB should be able to schedule a NPUSCH transmission for data or a HARQ-ACK feedback in any of the U=8 subframes corresponding to any D=8 DL subframes. The current Koffset and k0 combinations cannot properly schedule NPUSCH transmission in the U=8 subframes due to fixed set of values.

The systems and methods described herein may provide the following features and improvements:

### Koffset Configuration and Delay Indication for NPUSCH Transmission in IoT NTN TDD

The legacy Koffset to compensate the RTT is not necessary for IoT NTN TDD since the DL to UL guard period is already 50 ms. Also, the fixed value of Koffset cannot be used to indicate the subframes in the U=8 subframe set.

For IoT NTN TDD using the Iridium satellite system frequency band, there are two options.

Option 1: Koffset is not used/configured, and the NPUSCH is transmitted in the U=8 UL subframe set immediately after D=8 DL subframe timeslot that carries the end of the NPDCCH/NPDSCH transmission.

Option 2: Koffset is configured as the delay in a number of periods for the NPUSCH transmission, valid values are integer numbers from 0 to N, where N is the maximum number of delay periods, e.g. N=4 or 8.
If Koffset is not configured, or set as 0, the NPUSCH is transmitted in the U=8 UL subframe set immediately after the NPDCCH/NPDSCH transmission.
If Koffset is not configured with an integer number n, the NPUSCH is transmitted in the U=8 UL subframe set that is n periods after the NPDCCH/NPDSCH transmission.
An IoT NTN TDD period is 90 ms and a period includes a D=8 DL subframe timeslot in front of a U=8 UL subframe timeslot with a fixed guard period.

### Scheduling and Starting Subframe Indication for NPUSCH Format 1 Transmission in IoT NTN TDD

NPUSCH format 1 for data transmission is scheduled by DCI format N0.

### Legacy Method:

The starting position of the NPUSCH transmission is indicated by the 2-bit scheduling delay k0 field. In the legacy system, the k0 is selected from a set of 4 values [8, 16, 32, 64]. The Koffset and k0 combination determines the NPUSCH transmission location.

### New Method:

For IoT NTN TDD using the Iridium satellite system frequency band:

A NPUSCH with 3.75 kHz SCS requires four 90 ms periods with excessive delay. A NPUSCH with 15 kHz can be fully confined within a U=8 UL subframe timeslot. Only NPUSCH with 15 kHz may be supported for IoT NTN TDD.

In IoT NTN TDD, the k0 should be reused to reflect the relative subframe position in a U=8 UL subframe timeslot, where the U=8 timeslot is determined by the K_{offset} value (as in claim set 1). Ideally, the NPUSCH may be scheduled in any UL subframe in the U=8 UL subframe timeslot by a NPDCCH in any DL subframe in a D=8 DL subframe timeslot.

Case 1: A NPUSCH may start from any subframe in a U=8 UL subframe timeslot, the 2-bit scheduling delay field and the most significant bit in the subcarrier indication field can form 3-bits to indicate a subframe index in the U=8 subframe timeslot.

Case 2: A NPUSCH transmission is confined within a UL slot in a period, and the start points are limited based on scheduled number of subcarriers in a NPUSCH.
For I_{SC} from 0-11, the scheduling delay field should be always 00, and the NPUSCH transmission will occupy all subframes in the U=8 UL subframe timeslot.
For I_{SC} from 12-15, the scheduling delay field indicates two possible starting positions of subframe 0 or subframe 4 in the U=8 UL subframe timeslot, e.g. 00 for subframe 0 and 11 for subframe 4.
For I_{SC} from 16-17, the scheduling delay field indicates four possible starting positions of subframe 0, 2, 4, 6 in the U=8 UL subframe timeslot. For example, the scheduling delay field of 00 indicates subframe index 0, 01 indicates subframe 2, 10 indicates subframe 4, and 11 indicates subframe 6 as starting point in the U=8 timeslot.
For I_{SC}=18, same as Case 1, the 2-bit scheduling delay field and the most significant bit in the subcarrier indication field can form 3-bits to indicate a subframe index in the U=8 subframe timeslot.

### NPDSCH HARQ-ACK Feedback Timing Indication for NPUSCH Format 2 Transmission in IoT NTN TDD

NPUSCH format 2 for NPDSCH HARQ-ACK reporting is scheduled by DCI format N1. The 4-bit HARQ-ACK resource indication field is used to indicate the frequency resource and the transmission delay for the NPUSCH format 2 transmission.

### Legacy Method:

For 3.75 kHz SCS, in the HARQ-ACK resource field, 3 bits are used for HARQ-ACK subcarrier resources, and 1 bit for scheduling delay k0 selected from 2 fixed values of 13 and 21.
For 15 kHz SCS, in the HARQ-ACK resource field, 2 bits are used for HARQ-ACK subcarrier resources, and 2 bits for scheduling delay k0 selected from 4 fixed values of 13, 15, 17, and 18.

### New Method:

For IoT NTN TDD using the Iridium satellite system frequency band:

In the HARQ-ACK resource field, the ACK/NACK subcarrier part is maintained the same as legacy. But the scheduling delay k0 part is reused to indicate the starting subframe index within the U=8 UL subframe timeslot.
For 3.75 kHz SCS, the 1 bit for scheduling delay k0 is always 0, and the NPUSCH format 2 transmission starts from subframe 0 and occupies all subframe in the U=8 UL subframe timeslot.
For 15 kHz SCS, the 2 bits for scheduling delay k0 are selected from 4 fixed values of 0, 2, 4, 6 to indicate the starting subframe index within the U=8 UL subframe timeslot.

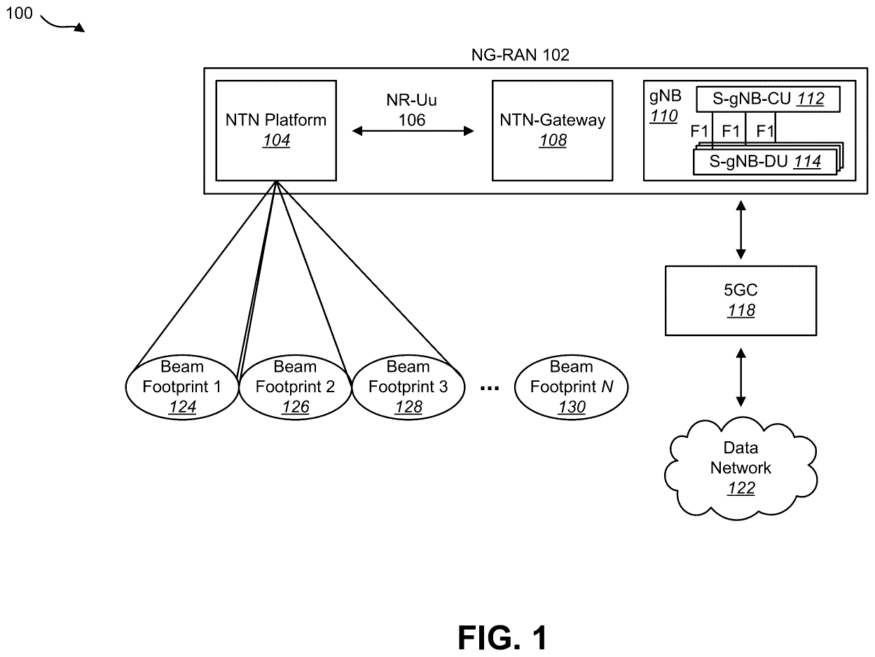

FIG. 1 is a diagram 100 illustrating an example of a non-terrestrial network (NTN) coverage area with a plurality of beams. The Next Generation Radio Access Network (NG-RAN) 102 includes an NTN-Platform 104 in communication with an NTN-Gateway 108 through a 5G air interface, such an NR-Uu 106 (New Radio User Equipment (UE) to the NR Node B (gNB) radio interface). The NG-RAN 102 also includes a base station device (gNB) 110. The gNB 110 includes an S-gNB-CU (Secondary gNodeB Control Unit) 112 and an S-gNB-DU (Secondary gNodeB Distributed Unit) 114 in communication with each unit via F1 interfaces.

The NTN coverage area includes a plurality of beams having footprints: beam footprints 1, 2, 3, . . . N (124, 126, 128, 130). The 5G Core network (5GC) 118 is in communication with the NG-RAN 102 and a data network 122, such as a global communications network or other data network.

### Background on IoT NTN TDD and Frame Structure

This description proposes the introduction of a new feature that allows the operator to use the radio resources in a periodic subset of the UL and DL subframes in N radio frames to achieve TDD operation in the SAN (Satellite Access Node) and IoT NTN UE, thus limiting power consumption. This feature allows extending 3GPP NB-IoT NTN operation with support for an additional NGSO satellite system.

The new feature will extend the deployment of NB-IoT NTN, by extending support to additional existing, in-orbit satellite resources, in particular additional existing Non-Geostationary Satellite Orbit (NGSO) systems, and including enabling additional lower-complexity satellite payloads, such as implementations without diplexer. With this proposed feature, there is a significant opportunity to further expand global NB-IoT NTN service coverage. This includes providing connectivity to polar regions.

This new feature should be designed to leverage commonalities with the NB-IoT frequency division duplex (FDD) NTN operation, for NGSO operating in 1616-1626.5 MHz, assuming this band will be defined as an unpaired spectrum in 3GPP. This will define a TDD mode for NB-IoT NTN systems. The feature is not intended to be applicable to existing 3GPP bands.

The work item aims to specify enhancements for NB-IoT NTN to enable NTN operation with a NB-IoT TDD mode leveraging commonalities with half-duplex NB-IoT FDD NTN, by defining a new NB-IoT TDD mode for NTN based on minimum necessary changes to the NB-IoT NTN FDD frame structure and procedures for the NB-IoT operation in the targeted unpaired mobile satellite service (MSS) allocated band (TN deployment is not expected in this band). The feature is not intended to be applicable to existing 3GPP bands.

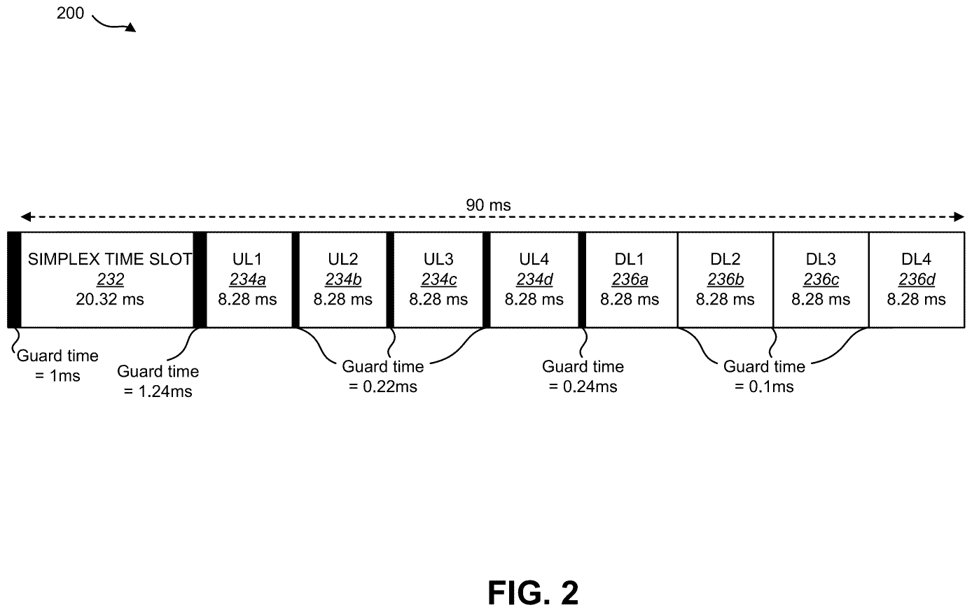

IoT NTN TDD is studied to support LTE NB-IoT using the Iridium satellite system frequency band. The legacy L-band system employs a time domain duplex (TDD) approach wherein they transmit and receive in an allotted time window within the frame structure. The fundamental unit of the TDMA channel is a time-slot. Time-slots are organized into frames. The frame consists of a 20.32 millisecond downlink simplex time-slot 232, followed by four 8.28 millisecond uplink time-slots (234a-234d) and four downlink time-slots (236a-236d), which provide the duplex channel capability. The TDMA frame also includes various guard times to allow hardware set up and to provide tolerance for uplink channel operations. The L-Band subsystem TDMA frame is illustrated in FIG. 2.

FIG. 2 is a diagram 200 illustrating an example of legacy L-band TDD frame structure. Each legacy DL slot (236a-236d) or legacy UL slot (234a-234d) is 8.28 ms, which is more than 8 ms for 8 full LTE subframes, the remaining 0.28 ms is less than 4 LTE symbols, thus up to 3 LTE symbols may be transmitted even if the whole legacy DL slot (236a-236d) or legacy UL slot (234a-234d) is used. Since D=8 and U=8 are used for the system design, the additional 0.28 ms may be ignored in most cases. Ignoring the simplex time slot 232 and the guard times around it, guard time exits are even between DL and UL timeslots. The guard time between different DL and UL slots are different in the legacy TDD frame structure, i.e. 0.22 ms between two UL slots, 0.24 ms between UL4 234d and DL1 236a, and 0.1 ms between two DL slots.

For backward compatibility of existing systems, new TDD structures are needed to align with the existing TDD frame structure. The time division multiplexing (TDM) frame period is maintained the same as legacy, i.e. 90 ms, thus, 9 LTE radio frames can be covered in a frame period. An LTE radio frame consists of 10 subframes, and each subframe consists of 2 slots.

Regarding operation within the same band as the TDD frame structure of legacy system in the 1.6 GHz MSS band:
At the satellite, all downlink NB-IoT channels/signals in a cell can only use one of the downlink slots in the TDD frame structure (DL1 236a, DL2 236b, DL3 236c, or DL4 236d) across 90 ms periods.
   The same downlink slot is used in all the 90 ms periods.
At the satellite, all uplink NB-IoT channels in a cell can only use one of the uplink slots in the TDD frame structure (UL1 234a, UL2 234b, UL3 234c, or UL4 234d) across 90 ms periods.
   The same uplink slot is used in all the 90 ms periods.
The one uplink slot and one downlink slot in the TDD frame structure have the same index (DL1 236a & UL1 234a, DL2 236b & UL2 234b, DL3 236c & UL3 234c, or DL4 236d & UL4 234d).

For the system design, D=8 and U=8 are defined with N=9 from point of view of the design constraints imposed by the TDD frame structure of the legacy system in the 1616-1626.5 MHz MSS band, where D=8 means 8 ms with a set of 8 consecutive DL subframes, and U=8 means 8 ms with a set of 8 consecutive UL subframes, and N=9 means the period is 90 ms which consists of 9 radio frames, and each radio frame is 10 ms as in legacy LTE.

An IoT NTN DL subframe set may also be known as an IoT NTN DL slot, an IoT NTN DL timeslot, and an IoT NTN DL subset, an IoT NTN DL instance or an IoT NTN DL interval, etc. An IoT NTN UL subframe set may also be known as an IoT NTN UL slot, an IoT NTN UL timeslot, and an IoT NTN UL subset, an IoT NTN UL instance or an IoT NTN UL interval, etc. In the remaining context, IoT NTN DL timeslot and IoT NTN UL timeslot will be used to differentiate from legacy DL slot and legacy UL slot as well as LTE DL slot and LTE UL slot.

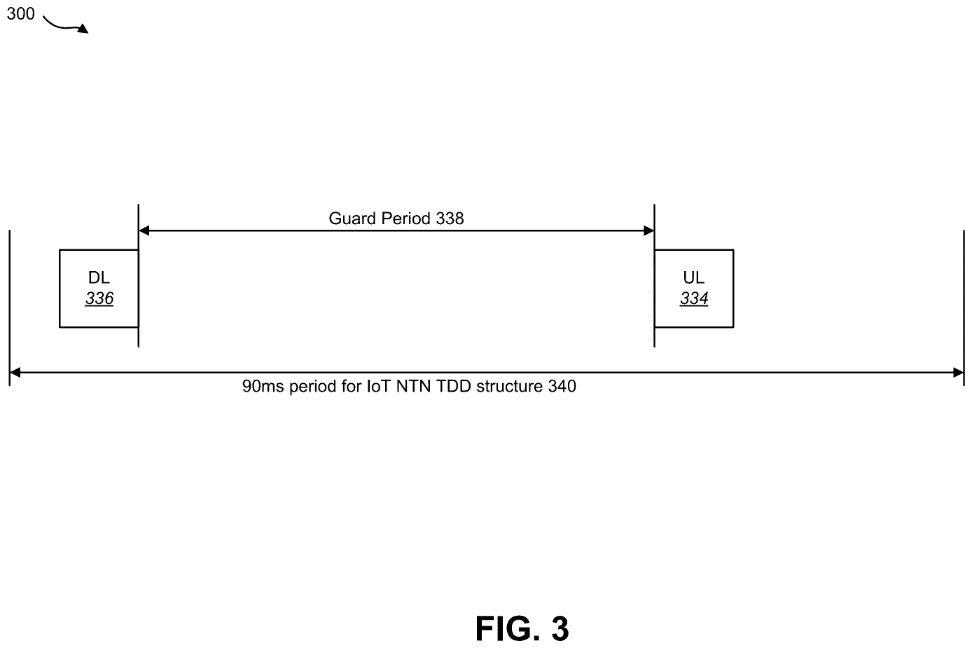

In IoT NTN TDD, there are 4 DL slots (236a-236d) and 4 UL slots (234a-234d), each DL slot should include an IoT NTN DL timeslot with 8 LTE DL subframes, each subframe with 1 ms. A UE can only receive in one of the IoT NTN DL timeslots in each 90 ms period. The DL and UL slot pair index may not be known at the UE, and can be handled by eNB with common TA in NTN. Thus, from the UE point of view, the system only has one DL slot and one UL slot in every period, as shown in FIG. 3.

FIG. 3 is a diagram 300 illustrating structure for an IoT NTN TDD cell with D=8 DL timeslot 336 and U=8 UL timeslot 334 within a 90 ms period 340. FIG. 3 assumes a D=8 DL timeslot 336 is in front of a U=8 UL timeslot 334 with the appropriate guard period 338 in between, and the DL timeslot 336 and UL timeslot 334 are in the same period. The 90 ms period 340 does not necessarily immediately start at the DL timeslot 336. The IoT NTN period boundaries may not be the same as legacy TDD frame structure periods.

The guard period 338 between the end of the downlink subframes 336 and the beginning of the uplink subframes 334 is fixed in specifications to be [48 . . . 50] ms at the uplink single reception port (ULSRP). This corresponds to the largest separation between DL and UL Iridium slot pairs. As shown in FIG. 2, due to different lengths of gap periods between DL and UL slots, different DL slot 336 and UL slot 334 pairs have different distances. In IoT NTN TDD design, only a single DL and UL slot pair are considered in a 90 ms from a single cell or IoT device point of view. The adjustments to align with different UL/DL pairs can be achieved by adjusting the common TA in the NTN system.

Different DL and UL pairs have different distances. Based on FIG. 2, the maximum distance is given by end of legacy DL4 236d to start of UL4 234d of the next period with a total of 48.06 ms. Assume the D=8 and U=8 subframes are transmitted in the center of the legacy DL 336 and UL slot 334, the guard period 338 will be 48.34 ms. If the D=8 subframe are at the beginning of legacy DL slot, and U=8 subframes are at the end of the legacy UL slot, the total guard period 338 will be 48.62 ms. For other DL and UL slot pairs, the guard period 338 is reduced by up to 0.12-0.36 ms from the maximum value. For simplicity, the fixed guard period in the specification can be set as 48.34 ms using the maximum DL and UL pair distance with slot center transmission assumptions.

In an IoT NTN TDD 90 ms period 340, only D=8 downlink subframes and U=8 subframes are available for DL and UL transmissions. The remaining subframes in the period are “non-D NB-IoT subframes” and “non-U NB-IoT subframes”.

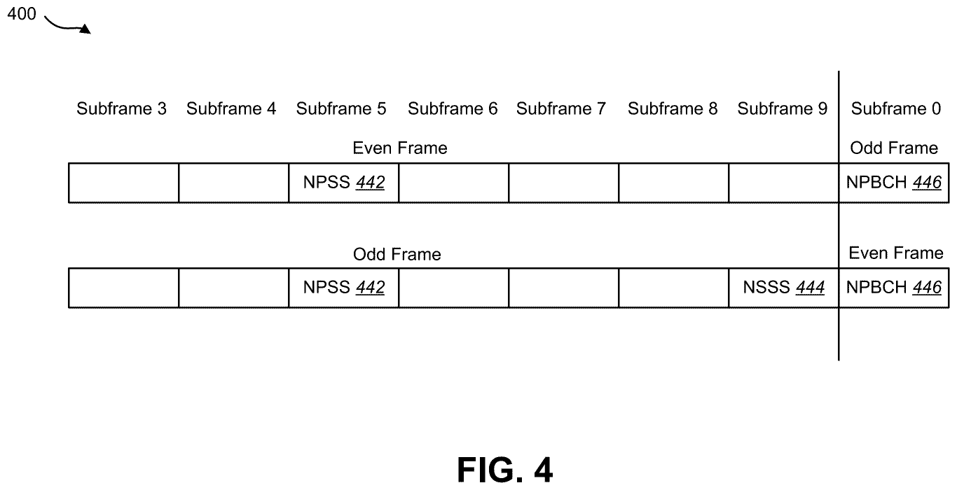

The downlink subframes within D=8 are fixed to subframe indexes with [3 4 5 6 7 8 9 0] across two consecutive radio frames. That is, subframes 3-9 in the first radio frame and subframe 0 of the second radio frame. The synchronization signals can be transmitted with legacy structure and positions as shown in FIG. 4.

FIG. 4 is a diagram 400 illustrating an example of synchronization signals in a D=−8 DL timeslot 336 of IoT NTN TDD. The Narrowband Primary Synchronization Signal (NPSS) 442 is transmitted in subframe 5 of the first radio frame, and Narrowband Physical Broadcast Channel (NPBCH) 446 is in subframe 0 of the second radio frame. The Narrowband Secondary Synchronization Signal (NSSS) 444 is present in subframe 9 of the first radio frame only if it is an odd number radio frame. In NB-IoT, the NPSS 442, NSSS 444, and NPBCH 446 occupy the full subframes, thus NPDCCH and NPDSCH cannot be transmitted in the subframes occupied by the synchronization signals and NPBCHs 446. The remaining subframe may be used for NPDCCH or NPDSCH transmissions. In NB-IoT, NPDCCH and NPDSCH cannot be scheduled in the same subframe. A subframe may be used for either NPDCCH or NPDSCH.

Alternatively, if the UL timeslot 334 is in front of the DL timeslot 336 in a period, the guard time will span cross two periods. The scheduling DCI indicated in a DL subframe in a DL timeslot 336 can only schedule UL transmissions in a UL subframe in the UL timeslot 334 of the next period at the earliest.

### NB-IoT NPUSCH Formats

IoT NTN TDD reuses NB-IoT FDD frame structure for NPUSCH, i.e. NPUSCH with frame structure type 1. NPUSCH channel is used to transport uplink user data and control information from upper layers. Moreover, NPUSCH carries HARQ-ACK for NPDSCH. NB-IoT uses only one Physical Resource Block (PRB) as maximum device scheduled bandwidth. NPUSCH supports two transmission formats depending on data it carries.

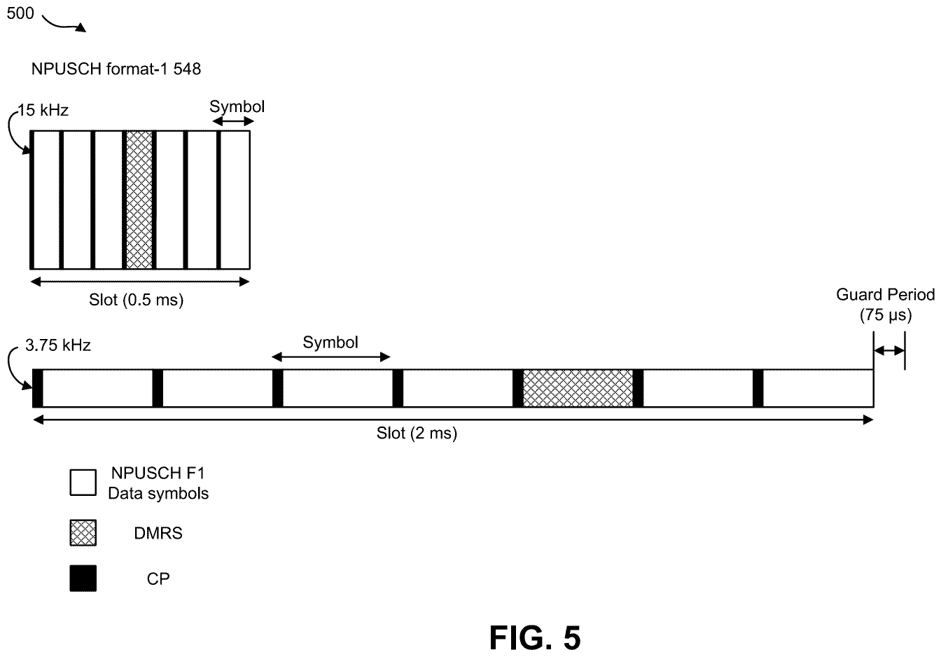

FIG. 5 is a diagram 500 illustrating an example of NPUSCH format 1 548. NPUSCH format 1 548 is used for carrying uplink data and uses same LTE turbo code for error correction. It supports UE bandwidth allocation smaller than one PRB. Maximum transport block (TB) size is 1000 bits. It supports multi-tone transmission based on LTE numerology. It also supports single tone transmission based on either 3.75 kHz or 15 kHz numerology. It uses π/2-BPSK or π/4-QPSK for single tone transmission to reduce Peak-to-Average Power Ratio (PAPR). It supports single layer transmission. It uses same slot structure as legacy PUSCH with 7 Orthogonal Frequency Division Multiplexing (OFDM) symbols per slot and a middle symbol as Demodulation Reference Signal (DMRS) used for channel estimation.

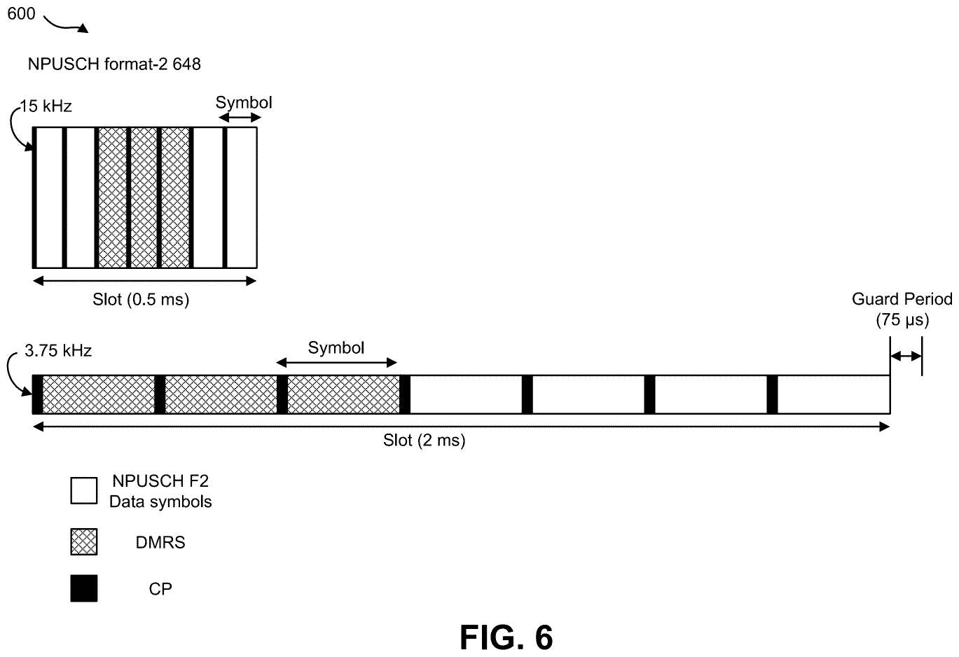

FIG. 6 is a diagram 600 illustrating an example of NPUSCH format 2 648. NPUSCH format 2 648 is used for signaling HARQ-ACK for NPDSCH. It uses repetition code for error correction. NPUSCH format 2 648 has 7 OFDM symbols per slot. It supports 3.75 kHz or 15 kHz numerology. It uses three symbols as DMRS used for channel estimation. It uses single tone transmission.

For NPUSCH, the resource units are used to describe the mapping of the NPUSCH to resource elements. A resource unit is defined as

$${N}_{symb}^{UL} {N}_{slots}^{UL}$$

SC-FDMA symbols in the time domain and

$${N}_{sc}^{RU}$$

consecutive subcarriers in the frequency domain, where

$${N}_{sc}^{RU} and {N}_{symb}^{UL}$$

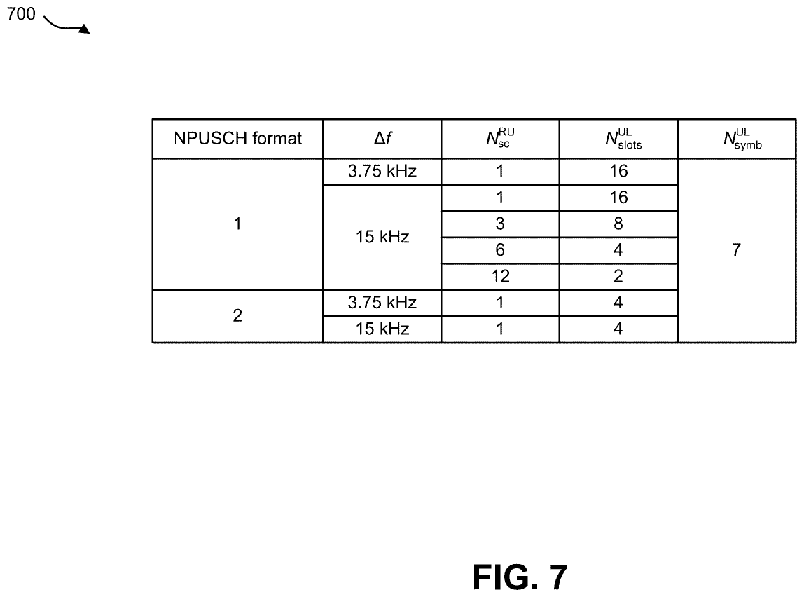

are given by the table in FIG. 7 for frame structure types 1, which illustrates an example of supported combinations of

$${N}_{sc}^{RU} , {N}_{slots}^{UL} , and {N}_{symb}^{UL}$$

for frame structure type 1.

### DCI Formats N0 for NB IoT NPUSCH

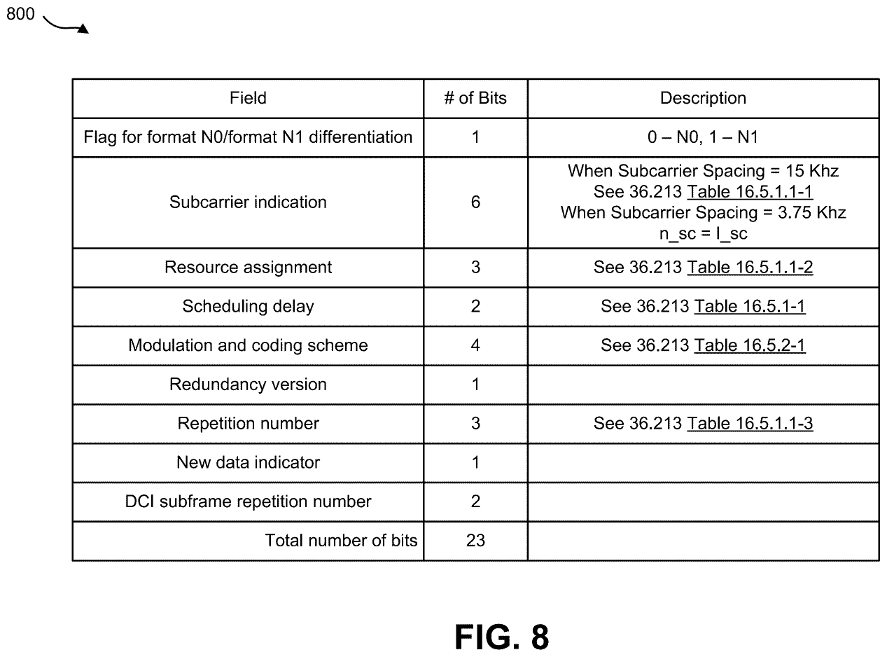

DCI Format NO is for a UL Grant, i.e. NPUSCH scheduling. Specifically, NPUSCH format 1 548 for data transmission. Each of the fields in DCI format N0 is defined and summarized in the table 800 shown in FIG. 8. In NR PUSCH, where the repetition number is semi-statically configured and not a part of the DCI. For IoT NPUSCH scheduling, all parameters are dynamically indicated in the DCI, including subcarrier indication, resource assignment, scheduling delay, MCS, and repetition number, etc.

A portion of the TS36.212 specification is included as follows:

### Downlink Control Information

A DCI transports downlink or uplink scheduling information for one cell and one Radio Network Temporary Identifier (RNTI). The RNTI is implicitly encoded in the Cyclic Redundancy Check (CRC). The processing structure for one DCI is according to Clause 5.3.3.

### DCI Format N0

DCI format N0 is used for the scheduling of NPUSCH and operation on preconfigured UL resources in one UL cell. The following information is transmitted by means of the DCI format NO:
Flag for format N0/format N1 differentiation-1 bit, where value 0 indicates format N0 and value 1 indicates format N1.
Modulation and coding scheme-4 bits as defined in clause 16.5.1.2 of [3]. This field is only present if format N0 CRC is scrambled by Paging User Radio Network Temporary Identifier (PUR-RNTI.)

If format N0 CRC is scrambled by PUR-RNTI and modulation and coding scheme is set to ‘1110’, the remaining fields are set as follows:
ACK or Fallback indicator—1 bit, where value 0 indicates ACK and value 1 indicates fallback as defined in clause 16.6.4 of [3].
NPUSCH repetition adjustment—3 bits refer to/Rep in Table 16.5.1.1-3 of [3].
Timing advance adjustment-6 bits as defined in clause 16.1.2 of [3]. The field is only present if ACK or Fallback indicator is set to 0.
All the remaining bits in format N0 are set to one.

Otherwise:
Subcarrier indication-6 bits as defined in clause 16.5.1.1 of [3].
Resource assignment-3 bits as defined in clause 16.5.1.1 of [3].
Scheduling delay-2 bits as defined in clause 16.5.1 of [3].
Modulation and coding scheme-4 bits as defined in clause 16.5.1.2 of [3]. This field is not present if format N0 CRC is scrambled by PUR-RNTI. If npusch-16QAM-Config is configured and the value is ‘1111’, it functions as 16QAM indicator.
Redundancy version-1 bit as defined in clause 16.5.1.2 of [3].
Repetition number-3 bits as defined in clause 16.5.1.1 of [3]. If 16QAM is indicated, it functions as Modulation and coding scheme for 16QAM as defined in 16.5.1.2 of [3].
New data indicator—1 bit. If multiple TB are scheduled, it functions as New data indicator for the first TB.
DCI subframe repetition number-2 bits as defined in clause 16.6 in [3].
Number of scheduled TB for Unicast-1 bit, where value 0 indicates a single TB is scheduled and value 1 indicates multiple TB are scheduled. This field is only present if higher layer parameter npusch-MultiTB-Config is enabled and the corresponding DCI is mapped onto the UE specific search space given by the C-RNTI as defined in [3]. The field is set to 0 if the CRC of the DCI is scrambled by SPS C-RNTI.
HARQ process number-1 bit. This field is only present if 2 HARQ processes are configured and the corresponding DCI format is mapped onto the UE specific search space given by the C-RNTI as defined in [3], or if Number of scheduled TB for Unicast is present. If multiple TB are scheduled, it functions as New data indicator for the second TB.
Resource reservation-1 bit as defined in clause 16.5 of [3]. This field is only present if higher layer parameter resourceReservationConfigUL is configured and the DCI is mapped onto the UE-specific search space given by C-RNTI as defined in [3].

If the number of information bits in format N0 mapped onto the UE specific search space given by the C-RNTI as defined in [3] is less than that of format N1 in the same search space, zeros shall be appended to format N0 until the payload size equals that of format N1.

[3] Refers to 3GPP TS 36.213: “Evolved Universal Terrestrial Radio Access (E-UTRA); Physical layer procedures.”

A portion of the TS36.213 specification is included as follows:

### UE Procedure for Transmitting Format 1 Narrowband Physical Uplink Shared Channel

NPUSCH format 1 transmission can be scheduled by a NPDCCH with DCI format N0, or the transmission can correspond to using preconfigured uplink resources configured by higher layers. Transmission using preconfigured uplink resource is initiated by higher layers as specified in, while retransmission of transport blocks transmitted using preconfigured uplink resource are scheduled by a NPDCCH with DCI format N0.

A UE shall upon detection on a given serving cell of a NPDCCH with DCI format N0 ending in NB-IoT DL subframe n scheduling NPUSCH intended for the UE, perform, at the end of:
n+k₀+K_{offset} DL subframe for FDD.
k₀ NB-IoT UL subframes following the end of n+8 subframe for TDD.

A corresponding NPUSCH transmission using NPUSCH format 1 548 in N consecutive NB-IoT UL slots nᵢ with i=0, 1, . . . , N−1 according to the NPDCCH information where:
subframe n is the last subframe in which the NPDCCH is transmitted and is determined from the starting subframe of NPDCCH transmission and the DCI subframe repetition number field in the corresponding DCI; and

$$N = {N}_{TB} {N}_{Rep} {N}_{RU} {N}_{slots}^{UL} ,$$

where the value of N_{Rep} is determined as specified in Clause 16.5.1.1, the value of N_{RU} is determined by the resource assignment field in the corresponding DCI (see Clause 16.5.1.1), the value of

$${N}_{slots}^{UL}$$

is the number of NB-IoT UL slots of the resource unit (defined in clause 10.1.2.3 of [3]) corresponding to the

$${N}_{sc}^{RU}$$

allocated number of subcarriers (as determined in Clause 16.5.1.1) in the corresponding DCI, and the value of N_{TB} is determined by the Number of scheduled TB for Unicast field, if present, in the corresponding DCI, N_{TB}=1 otherwise:
n₀ is the first NB-IoT UL slot starting after the end of subframe n+k₀+K_{offset} for FDD.
n₀ is the first NB-IoT UL slot starting after k₀ NB-IoT UL subframes following the end of n+8 subframe for TDD.
value of k₀ is determined by the scheduling delay field (I_{Delay}) in the corresponding DCI according to Table 16.5.1-1 for FDD and Table 16.5.1-1A for TDD.
For N_{TB}>1:
   if the UE is configured with higher layer parameter npusch-MultiTB-Config set to ‘interleaved’, and NPUSCH corresponding to a NPDCCH with DCI CRC scrambled by C-RNTI, and N_{Rep}>C where C=1 for

$${N}_{sc}^{RU} = 1 , C = 4$$

otherwise:
NB-IoT UL slots n_{g}·(c·N_{TB}+r)+l with
l=0,1, . . . g−1, c=0,1, . . . N_{Rep}/C−1,

$$g = {CN}_{RU} {N}_{slots}^{UL}$$

are associated with
TBr+1, r=0,1, . . . N_{TB}−1
Otherwise:
   NB-IoT UL slots

$${}^{n} r \cdot {N}_{Rep} {N}_{RU} {N}_{slots}^{UL} + l with l = 0 , 1 , … {N}_{Rep} {N}_{RU} {N}_{slots}^{UL} - 1$$

are associated with TBᵣ₊₁, r=0,1, . . . N_{TB}−1

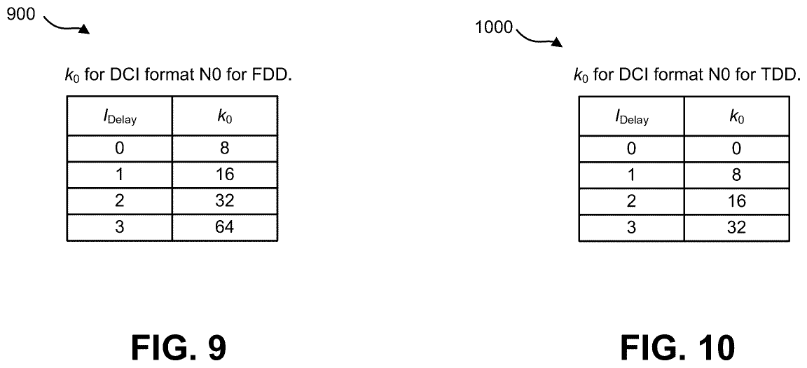

FIG. 9 is a table 900 illustrating an example of k₀ for DCI format N0 for FDD.

FIG. 10 is a table 1000 illustrating an example of k₀ for DCI format N0 for TDD.

### DCI Format N1 for IoT NPDSCH Scheduling and HARQ-ACK Feedback

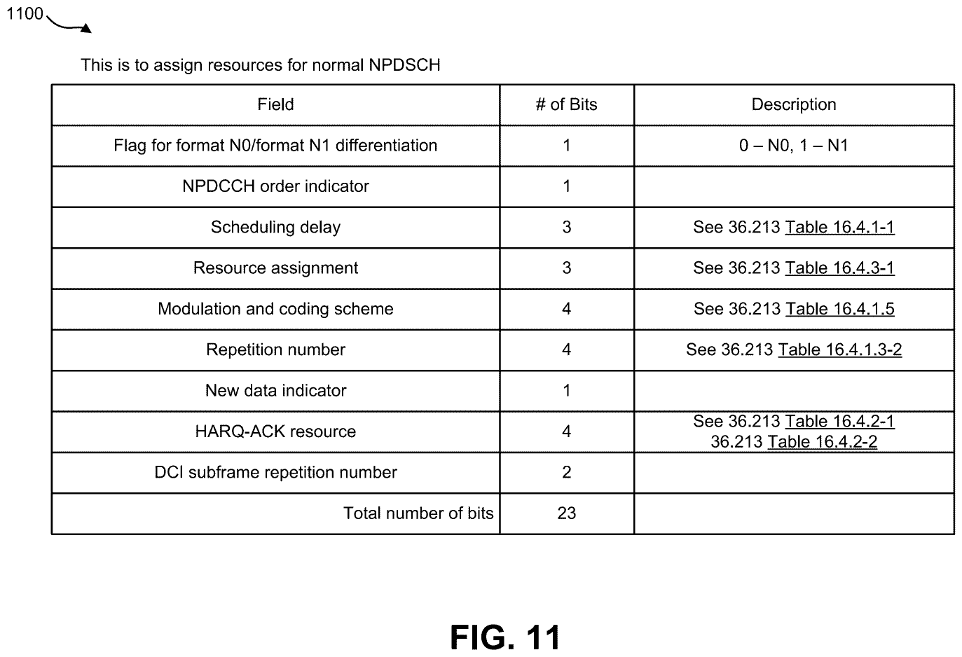

DCI Format N1 is for all NPDSCH (user data and SIBs) except NPDSCH carrying paging and to trigger PRACH (non-contention based). Each of the fields in DCI format N0 is defined in the table 1100 shown in FIG. 11 which is to assign resources for normal NPDSCH.
<NPDCCH order=0, N1 CRC not masked with RA-RNTI>

A portion of the TS36.212 specification is included as follows:

### DCI Format N1

DCI format N1 is used for the scheduling of one NPDSCH codeword per TTI in one cell, random access procedure initiated by a NPDCCH order, notifying Single-Cell Multicast Control Channel (SC-MCCH) change, and operation on preconfigured UL resources. The DCI corresponding to a NPDCCH order is carried by NPDCCH.

The following information is transmitted by means of the DCI format N1:
If the format N1 CRC is scrambled by C-RNTI or RA-RNTI or PUR-RNTI:
   Flag for format N0/format N1 differentiation-1 bit, where value 0 indicates format N0 and value 1 indicates format N1.
   NPDCCH order indicator—1 bit.
Else if the format N1 CRC is scrambled by a G-RNTI:
   Information for SC-MCCH change notification-2 bits as defined in clause 5.8a of [6].

Format N1 is used for random access procedure initiated by a NPDCCH order only if NPDCCH order indicator is set to ‘1’, format N1 CRC is scrambled with C-RNTI, and all the remaining fields are set as follows:
Preamble format indicator—1 bit, where value 0 indicates preamble format 0/1 and value 1 indicates preamble format 2. This field is only present if nprach-ParametersListFmt2 is configured and the UE indicates the nprach-Format2 capability.
Starting number of NPRACH repetitions-2 bits as defined in clause 16.3.2 of [3].
   Subcarrier indication of NPRACH-6 or 8 bits, this field is 8 bits only if the preamble format indicator is present and set to 1, as defined in clause 16.3.2 of [3].
   Carrier indication of NPRACH-4 bits as defined in clause 16.3.2 of [3]. This field is only present if ul-ConfigList is configured and the UE indicates the multiCarrier-NPRACH capability.
All the remaining bits in format N1 are set to one.

Otherwise:
Scheduling delay—3 bits as defined in clause 16.4.1 of [3].
Resource assignment—3 bits as defined in clause 16.4.1.3 of [3].
Modulation and coding scheme—4 bits as defined in clause 16.4.1.5 of [3]. If npdsch-16QAM-Config is configured and the value is ‘1111’, it functions as 16QAM indicator.
Repetition number—4 bits as defined in clause 16.4.1.3 of [3]. If 16 QAM is indicated, it functions as Modulation and coding scheme for 16QAM as defined in 16.4.1.5 of [3].
New data indicator—1 bit. If multiple TB are scheduled, it functions as a new data indicator for the first TB.
HARQ-ACK resource—4 bits as defined in clause 16.4.2 of [3].
DCI subframe repetition number—2 bits as defined in clause 16.6 in [3].
Number of scheduled TB for the Single-Cell Multicast Traffic Channel (SC-MTCH)—3 bits, indicating from 1 to 8 TBs. This field is only present if higher layer parameter sc-mtch-InfoListMultiTB-r16 is enabled and the CRC of the DCI is scrambled by the Group Radio Network Temporary Identifier (G-RNTI.)
Number of scheduled TB for Unicast—1 bit, where value 0 indicates a single TB is scheduled and value 1 indicates multiple TB are scheduled. This field is only present if higher layer parameter npdsch-MultiTB-Config is enabled and the corresponding DCI is mapped onto the UE specific search space given by the Cell Radio Network Temporary Identifier (C-RNTI) as defined in [3].
HARQ process number—1 bit. This field is only present if 2 HARQ processes are configured and the corresponding DCI format is mapped onto the UE specific search space given by the C-RNTI as defined in [3], or if the number of scheduled TB for Unicast is present. If multiple TB are scheduled, it functions as a new data indicator for the second TB.
Resource reservation—1 bit as defined in clause 16.4 of [3]. This field is only present if higher layer parameter resourceReservationConfigDL is configured and the DCI is mapped onto the UE-specific search space given by C-RNTI as defined in [3].

When the format N1 CRC is scrambled with a Random Access Radio Network Temporary Identifier (RA-RNTI) or a G-RNTI, then the following fields among the fields above are reserved for RA-RNTI and not present for G-RNTI:
New data indicator.
HARQ-ACK resource.

If the number of information bits in format N1 mapped onto the same search space is less than that of format N0 and the format N1 CRC is not scrambled by G-RNTI, zeros shall be appended to format N1 until the payload size equals that of format N0.

The HARQ-ACK for NPDSCH is reported on NPUSCH format 2 648 as discussed above. The HARQ-ACK reporting procedure is described in TS36.213, which is reproduced below.

A portion of the TS36.213 specification is included as follows:

### UE Procedure for Reporting ACK/NACK

The UE shall upon detection of a NPDSCH transmission ending in NB-IoT subframe n intended for the UE and for which an ACK/NACK shall be provided, start, after the end of:

$$n + {k}_{0}^{′} + {K}_{offset} - 1$$

DL subframe for FDD.
[symbol] NB-IoT UL subframes following the end of n+12 subframe for TDD.

Transmission of the NPUSCH carrying ACK/NACK response, and SR (if any) if the serving cell is FDD and the UE is configured with higher layer parameter sr-with-HARQ-ACK-Config, using NPUSCH format 2 648 in N consecutive NB-IoT UL slots, where:

$$N = {N}_{TB}^{′} {N}_{Rep}^{AN} {N}_{slots}^{UL} ,$$

where
   the value of

$${N}_{Rep}^{AN}$$

given by the higher layer parameter ack-NACK-NumRepetitions-Msg4 configured for the associated NPRACH resource for Msg4 NPDSCH transmission, and higher layer parameter ack-NACK-NumRepetitions, otherwise:
the value of

$${N}_{slots}^{UL}$$

is the number of slots of the resource unit (defined in clause 10.1.2.3 of [3]), and
if the UE is configured with higher layer parameter harq-ACK-Bundling in npdsch-MultiTB-Config, then

$${N}_{TB}^{′} = 1 , otherwise {N}_{TB}^{′} = {N}_{TB} ,$$

where the value of N_{TB} is determined by the Number of scheduled TB for Unicast field if present in the NPDCCH corresponding to the NPDSCH, otherwise N_{TB}=1,
allocated subcarrier for ACK/NACK and value of k₀ is determined by the ACK/NACK resource field in the DCI format of the corresponding NPDCCH according to Table 16.4.2-1, and Table 16.4.2-2,
   for FDD,

$${k}_{0}^{′} = {k}_{0} .$$

for TDD, [symbol]
For N_{TB}>1
   if the UE is configured with higher layer parameter harq-AckBundling in npdsch-MultiTB-Config, and the NPDSCH corresponding to a NPDCCH with DCI CRC scrambled by C-RNTI,
the ACK/NACK response is generated by performing a logical AND operation of HARQ-ACKs corresponding to the TBᵣ₊₁, r=0,1, . . . N_{TB}−1
   Otherwise:
      NB-IoT UL slots

$${n}_{r} \cdot {N}_{Rep}^{AN} {N}_{slots}^{UL} + l with l = 0 , 1 , ... {N}_{Rep}^{AN} {N}_{slots}^{UL} - 1$$

of the NPUSCH carry ACK/NACK response for TBᵣ₊₁, r=0,1, . . . N_{TB}−1

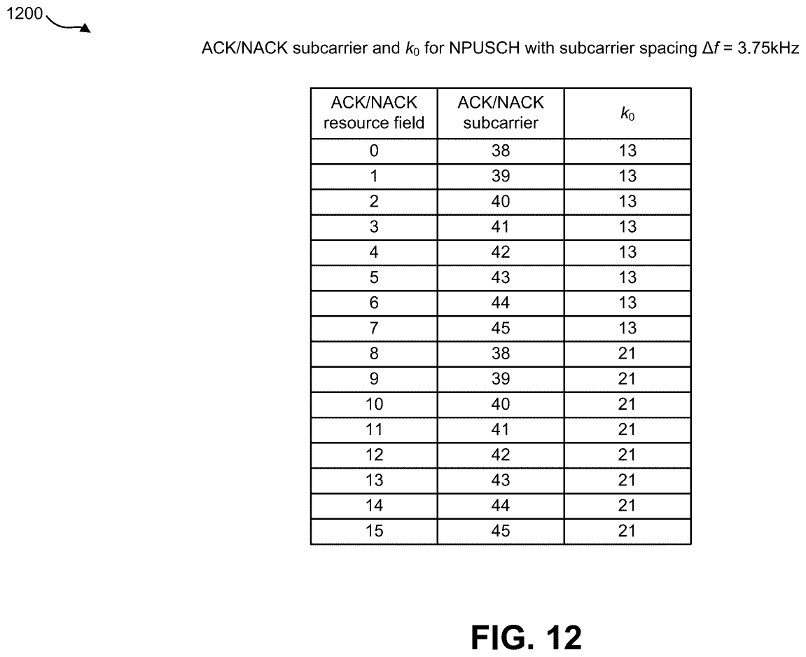

FIG. 12 is a table 1200 illustrating an example of ACK/NACK subcarrier and k₀ for NPUSCH with subcarrier spacing Δf=3.75 kHz.

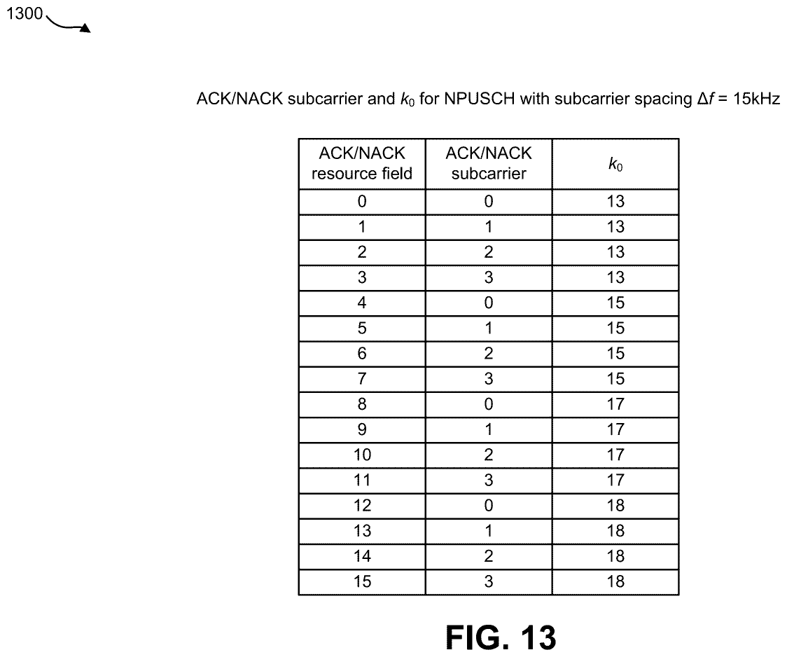

FIG. 13 is a table 1300 illustrating an example of ACK/NACK subcarrier and k₀ for NPUSCH with subcarrier spacing Δf=15 kHz.

### Issues and Solutions for Delay Indication of IoT NPUSCH Transmission

The IoT NTN TDD on Iridium frequency band is designed by leveraging commonalities with the NB-IoT half duplex FDD NTN operation. Thus, the DCI formats, DCI field and NPUSCH transmission procedures should follow NB-IoT FDD systems.

### For NPUSCH Format 1 Transmission:

A UE shall upon detection on a given serving cell of a NPDCCH with DCI format N0 ending in NB-IoT DL subframe n scheduling NPUSCH intended for the UE, perform, at the end of:
n+k₀+K_{offset} DL subframe for FDD.
k₀ NB-IoT UL subframes following the end of n+8 subframe for TDD.

A corresponding NPUSCH transmission using NPUSCH format 1 548 in N consecutive NB-IoT UL slots nᵢ with i=0, 1, . . . , N−1 according to the NPDCCH information.

The initial or first NPUSCH transmission subframe n0 is determined as follows:
n₀ is the first NB-IoT UL slot starting after the end of subframe n+k₀+K_{offset} for FDD.
n₀ is the first NB-IoT UL slot starting after k₀ NB-IoT UL subframes following the end of n+8 subframe for TDD.

### For NPUSCH Format 2 Transmission for NPDSCH HARQ-ACK Feedback:

The UE shall upon detection of a NPDSCH transmission ending in NB-IoT subframe n intended for the UE and for which an ACK/NACK shall be provided, start, after the end of:

$$n + {k}_{0}^{′} + {K}_{offset} - 1$$

DL subframe for FDD.
[symbol] NB-IoT UL subframes following the end of n+12 subframe for TDD.

Transmission of the NPUSCH carrying ACK/NACK response, and SR (if any) if the serving cell is FDD and the UE is configured with higher layer parameter sr-with-HARQ-ACK-Config, using NPUSCH format 2 648 in N consecutive NB-IoT UL slots:
for FDD,

$${k}_{0}^{′} = {k}_{0} .$$

for TDD,

[symbol]

The IoT NTN TDD on Iridium frequency band is designed by leveraging commonalities with the NB-IoT half duplex FDD. Thus, the NPUSCH transmission procedure and NPDSCH HARQ-ACK reporting procedure may follow an FDD case.

On the other hand, it is possible to use NB-IoT TDD methods for delay and timing determination in the NPUSCH transmission procedure and NPDSCH HARQ-ACK reporting procedure. In this case, the applicability of K_{offset} parameter, DCI fields, and interpretation need to be specified explicitly.

For both NB-IoT FDD and TDD methods, there are some issues when they are applied to IoT NTN TDD networks with limited D=8 and U=8 subframes in every 90 ms period 340, as discussed in detail below. Some methods may be considered to adjust the DCI fields and parameters to fit the IoT NTN TDD scenarios. Especially, from the scheduling timing point of view, it is desirable and beneficial if the NPUSCH transmission can be scheduled in any of the subframes in a U=8 UL subframe timeslot from any DL subframe in a D=8 DL subframe timeslot.

### Issue 1: K_{offset} Indication and Function

K_{offset} is a separately configured parameter for scheduling delays in NB-IoT. Whether and how to apply it for IoT NTN should be studied.

The K_{offset} is supported for NB-IoT FDD. In an NB-IoT TDD case, a fixed value is used instead of K_{offset}, e.g. for NPUSCH format 1 transmission, the 8 ms delay can be viewed as K_{offset}, and for NPUSCH format 2 transmission of NPDSCH HARQ-ACK reporting, the 12 ms delay can be viewed as K_{offset}.

In current NB-IoT FDD, a UE shall upon detection on a given serving cell of a NPDCCH with DCI format N0 ending in NB-IoT DL subframe n scheduling NPUSCH intended for the UE, perform, at the end of n+k₀+K_{offset} DL subframe for FDD a corresponding NPUSCH transmission using NPUSCH format 1 548 in N consecutive NB-IoT UL slots nᵢ with i=0, 1, . . . , N−1 according to the NPDCCH information. The same K_{offset} is also used to determine the delay time for HARQ-ACK reporting with NPUSCH format 2 transmissions, i.e. the NPDSCH HARQ-ACK timing indication.

K_{offset} is a separately configured parameter for scheduling offset that needs to be larger than or equal to the sum of the service link Round Trip Time (RTT) and the Common Time Advance (TA). The K_{offset} is designed to account for the propagation delay and other timing variations that can occur during communication between the NB-IoT device and the network. By ensuring that the scheduling offset is large enough, the network can properly schedule transmissions and receptions, even in the presence of these variations.

Since IoT NTN TDD leverage NB-IoT FDD half duplex operations, the K_{offset} should also be applicable. However, in IoT NTN TDD, K_{offset} may not be necessary since there is a big guard period already between the DL timeslot 336 and UL timeslot 334. Also, a fixed K_{offset} cannot be adjusted to indicate the UL subframe index within the U=8 UL timeslot 334.

Furthermore, the eNB should be able to schedule NPUSCH in any subframe index in the U=8 timeslot. A fixed K_{offset} value, even combined with k0, is still not sufficient. For example, to schedule the same NPUSCH starting point in a U=8 timeslot, the distances from different DL subframes in the D=8 timeslot are different. Thus, the K_{offset} value should be different depending on position of the DL subframe carrying the scheduling DCI in the D=8 timeslot.

If the NB-IoT TDD method is used to determine the scheduling delay, there may be similar issues since the fixed delay is equivalent to K_{offset} in FDD case. In NB-IoT TDD, the UL transmission is at the first NB-IoT UL slot starting after k0 NB-IoT UL subframes following the end of n+8 subframe. Due to fixed delay on the number of UL subframes, the UL subframe index in a U=8 UL subframe timeslot is somehow fixed based on the corresponding DL subframe index in the D=8 DL subframe timeslot. Since some of the DL subframes in the D=8 DL subframe timeslot are occupied by synchronization signals already, the eNB is not able to schedule NPUSCH in any subframe index in the U=8 timeslot. Also, the postponement of UL transmissions by counting the UL subframe only as in TDD method will cause excessive scheduling delay since there are only 8 UL subframes available in each 90 ms period 340.

There is around a 50 ms delay between D=8 DL subframe timeslot and the U=8 UL subframe timeslot already. Additional delay should be added depending on the subframe index of the DL transmission in the D=8 DL subframe timeslot and the subframe index of the UL transmission in the U=8 UL subframe timeslot. The guard period 338 itself is much more than the RTT and common TA for NTN IoT devices. Thus, there may be no need for additionally K_{offset} indication in NB-IoT TDD system.

Thus, in one option (Option 1), the K_{offset} is not used for IoT NTN, and the subframe alignment can be performed by the common TA indicated by the NTN gNB/satellite with the fixed guard period, and no addition configuration is needed. In this option, K_{offset} should not be configured and should not be applied. The NPUSCH should be transmitted starting in the immediate U=8 UL subframe timeslot after the NPDCCH/NPDSCH transmission. In case of NPUSCH format 1 548, the NPDCCH contains the scheduling DCI format N0. For NPDSCH, a NPUSCH format 2 648 is transmitted to provide the HARQ-ACK feedback for the NPDSCH.

In another option (Option 2), the K_{offset} can be reused to indicate additional periods for scheduling delay. The additional delay may be necessary, considering at least:
the limited DL subframes for UL scheduling;
the limited UL resources for NPUSCH transmissions; and
potential large number of repetitions needed for a NPUSCH transmission due to the distance of satellite links, etc.

In this option, a value for the K_{offset} can be an integer number to indicate the number of periods after the end of NPDCCH with DCI NO scheduling information for NPUSCH format 1 transmission. For example, a value of 0 means the immediate U=8 UL timeslot 334 after the end of NPDCCH with DCI NO scheduling information; a value of 2 means to use the U=8 UL timeslot 334 that is 2 periods (i.e 180 ms) later after the end of NPDCCH with DCI NO scheduling information.

Similarly, a value for the K_{offset} can be an integer number to indicate the number of periods after the end of NPDSCH transmission scheduled by a DCI format N1 with HARQ-ACK resource indication for a NPUSCH format 2 transmission.

The same K_{offset} parameter and value can be applied for both NPUSCH format 1 548 and NPUSCH format 2 transmissions. The valid values may be integer numbers from 0 to N, where N is the maximum number of delay periods, e.g. N=4 or 8 or 16. If only the UL subframes are counted, a maximum value N=4 will have a maximum delay of 32 UL subframes across 4 periods; a maximum value N=8 will allow a maximum delay of 64 UL subframes across 8 periods.

If Koffset is not configured, or set as 0, the NPUSCH is transmitted in the U=8 UL subframe set immediately after the NPDCCH/NPDSCH transmission. If Koffset is not configured with an integer number n, the NPUSCH is transmitted in the U=8 UL subframe set that is n periods after the NPDCCH/NPDSCH transmission.

### Issue 2: The Scheduling Delay k₀ Indication in DCI Format N0 for NPUSCH Format 1

Most of the DCI format N0 fields can be reused for IoT NTN TDD NPUSCH scheduling, e.g. the subcarrier indication, resource assignment, Modulation and Coding Scheme (MCS) setting, etc. Only NPUSCH format 1 548 based on FDD should be supported in IoT NTN TDD.

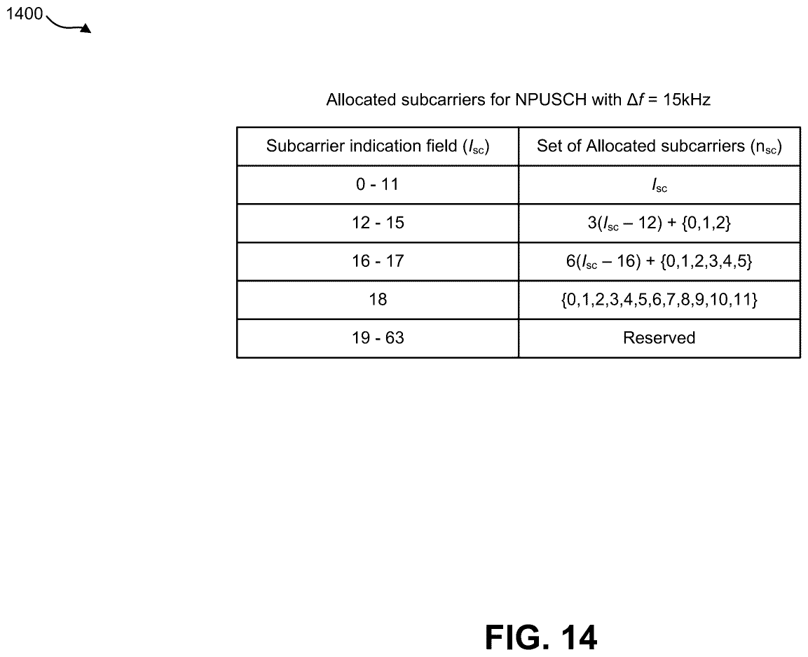

For NPUSCH transmission with subcarrier spacing Δf=15 kHz, the subcarrier indication field (I_{sc}) in the DCI or npusch-SubCarrierSetIndex in PUR-Config-NB for NPUSCH transmissions using preconfigured uplink resources determines the set of contiguously allocated subcarriers (n_{sc}) according to the table 1400 shown in FIG. 14, which shows an example of Allocated subcarriers for NPUSCH with Δf=15 kHz.

In DCI format N0, the subcarrier indication field has 6 bits, and not all bits are used in current standard. For NPUSCH transmission with subcarrier spacing Δf=3.75 kHz, n_{sc}=I_{sc} where I_{sc} is the subcarrier indication field and I_{sc}=48,49, . . . ,63 is reserved, or n_{sc} is configured by higher layer parameter npusch-SubCarrierSetIndex in PUR-Config-NB for NPUSCH transmissions using preconfigured uplink resources.

When Subcarrier Spacing=3.75 kHz, n_sc=I_sc, i.e. the subcarrier index is the same as the subcarrier indication index. Since only a single physical resource block (PRB) is supported, the index is from 0 to 11 within the resource block. Thus, only 4 bits are used in the subcarrier indication field, the two most significant bits are unused for the indication.

If a 3.75 kHz SubCarrier Spacing (SCS) is used, each slot is 2 ms, only 4 slots are available in a U=8 timeslot, and 16 slots are needed to transmit a NPUSCH as shown in the table, thus a NPUSCH with 3.75 kHz SCS will spread into 4 periods, i.e. 360 ms. That is very long delay and inefficient. Thus, only 15 kHz SCS may be supported for NPUSCH in IoT NTN TDD, 3.75 kHZ SCS NPUSCH may not be supported in IoT NTN TDD.

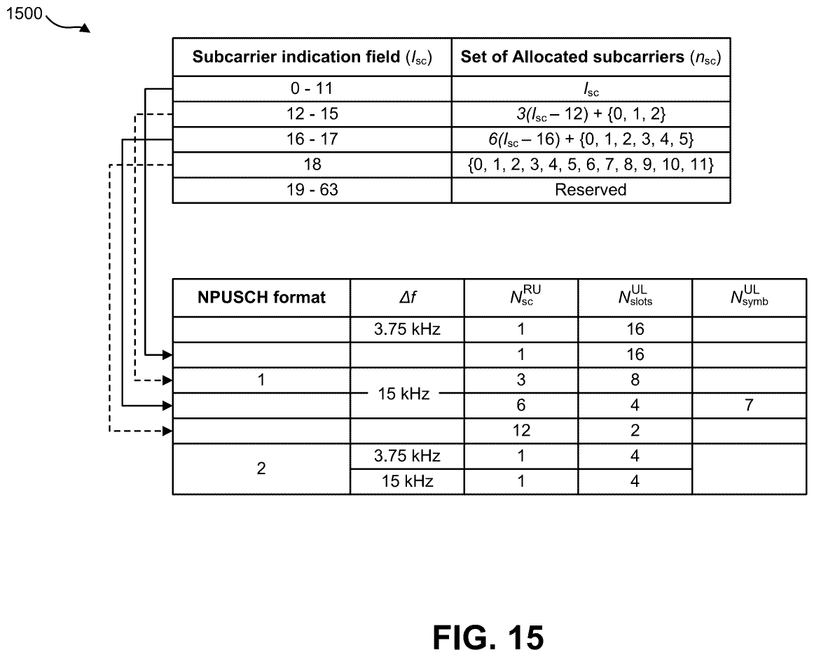

FIG. 15 shows two tables 1500 which demonstrate how the subcarrier indication field in DCI format N0 specifies the specific subcarriers to allocate UL resource for 15 kHz SCS.

As shown in FIG. 15, for NPUSCH format 1 548 with a single subcarrier, i.e. single tone NPUSCH, only index 0-11 is used. Thus, only 4 bits are used in the subcarrier indication field, and the two most significant bits are unused for the indication.

For NPUSCH with more than one subcarrier, i.e. multi-tone NPUSCH, up to 12 subcarriers can be used. The subcarrier indication field uses index 0-18. Thus, 5 bits are used, and the most significant bit is unused for the indication.

In DCI format N0, the scheduling delay field has 2 bits with 4 possible values to indicate the delay parameter k₀ as shown in Table 16.5.1-1 in TS 36.213. Note that k₀ values are multiples of 8 subframes in FDD networks.

In IoT NTN TDD, if the k0 is maintained as the distance from the NPDCCH with DCI format N0 to the NPUSCH transmission, the indicated subframes are most likely not in the U=8 uplink slot since there is only a single U=8 UL timeslot 334 in a period of 90 ms.

If k0 is interpreted based on the available or valid uplink subframe in the U=8 timeslots only as in NB-IoT TDD case, the different k0 values will lead to long delays into multiple periods, e.g. a k0=32 will need 4 U=8 timeslots. With period of 90 ms, it will be postponed to 360 ms later at least besides the fixed DL to UL distance. Additionally, the k0 cannot indicate the subframe index within the U=8 UL timeslot 334 either since it is a multiple of 8. The same subframe index within the U=8 timeslot will always be used.

As shown in FIG. 4, some DL subframes are already occupied with synchronization signals, and the remaining subframe may be used for NPDCCH and NPDSCH. With limited subframes for NPDCCH scheduling, with existing Koffset and k0 indication, the subframes that can be indicated in the UL timeslot 334 will also be limited. Furthermore, the NPUSCH normally occupies multiple slots and subframes, the limited number of starting positions in a U=8 UL subframe timeslot will lead to segmented NPUSCH transmissions if the remaining number of slots is not enough for the scheduled NPUSCH transmission. This will cause more specification impact and performance degradation.

NPUSCH Start Position Indication within U=8 Timeslot in DCI Format NO

NPUSCH is mapped as per current specifications. With only one UL timeslot 334 in a period, NPUSCH should be scheduled within the U=8 timeslot with any slot starting positions. Since the number of slots for an NPUSCH is at least two, a subframe index within the U=8 timeslot is enough.

The non-U NB-IoT subframes are not considered by the UE as “NB-IoT UL subframes” from the specifications. The “non-U NB-IoT subframes” are subframes not contained within the set of U=8 usable consecutive uplink subframes in the TDD structure.

The DL to UL guard period 338 is already around 50 ms without considering the subframe indexes in the D=8 timeslot and U=8 timeslot. The total delay is closer to the maximum delay of 64 ms in the current delay parameter. The next available U=8 timeslot will be 90 ms later based on the periodicity.

Thus, to minimize the scheduling delay of UL transmission, the NPUSCH transmission may always start in the next U=8 timeslot after the D=8 slot that carries the scheduling DCI indication. Since the guard period 338 is fixed for IoT NTN TDD subframe structure, the legacy delay indicator filed can be reused to indicate the starting subframe index within the U=8 timeslot.

Case 1: A NPUSCH Transmission can Start from any Subframe in a UL Slot

In one case, a NPUSCH transmission may be scheduled from any UL subframe in the U=8 timeslot, and a UL timeslot 334 cannot provide all the time domain resources for the NPUSCH transmission. The NPUSCH transmission may be segmented, and the remaining transmissions can be postponed to the U=8 UL timeslot 334 in the next period. However, this case will have segmented NPUSCH transmissions with long UL transmission gaps. On the other hand, it provides more flexibility on NPUSCH scheduling.

In this case, since there are 8 subframe in the U=8 timeslot, 3 bits are needed to indicate the starting position of the NPUSCH transmission in a timeslot. There are 2 bits in the scheduling delay field, one additional bit should be provided from other DCI fields or by a separate signaling.

To maintain the DCI size, one additional bit can be borrowed from other DCI fields. The reserved bit in the subcarrier indication field may be reused for scheduling delay indication. As discussed above, out of the 6 bits for subcarrier indication field, only 4 bits are used for NPUSCH with 3.75 kHZ SCS and single tone NPUSCH with 15 kHZ SCS. And 5 bits are used for multi-tone NPUSCH with 15 kHZ SCS.

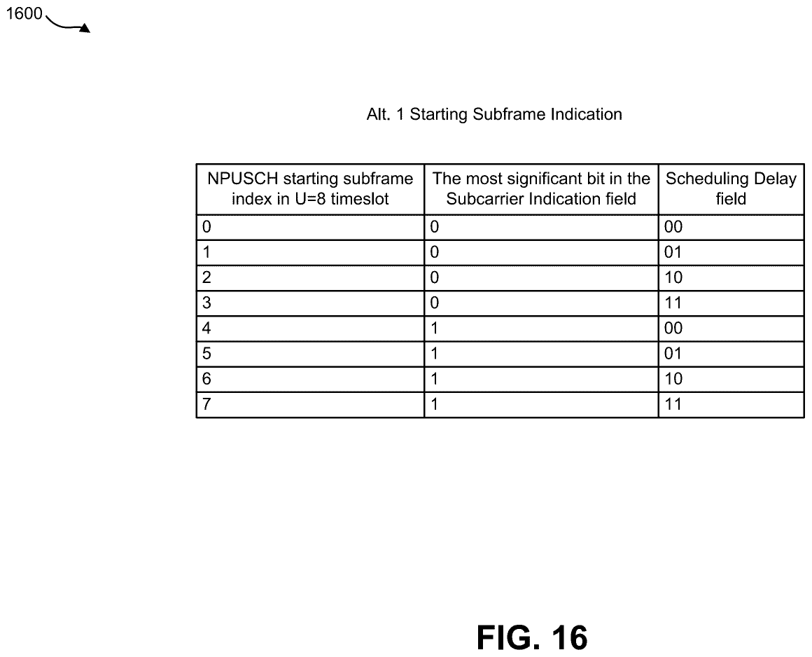

In one alternative (Alt. 1), to support scheduling of 15 kHz SCS NPUSCH, the unused bit (i.e. the most significant bit in the Subcarrier Indication field) can be used together with the 2-bit scheduling delay field to indicate the subframe index in the U=8 timeslot. FIG. 16 is a table 1600 demonstrating an alternative to starting subframe indication.

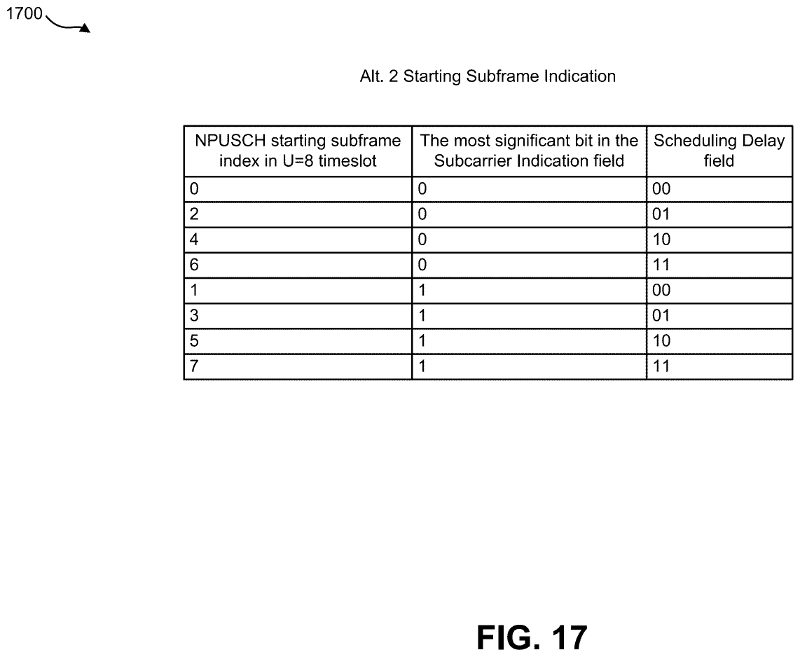

In another alternative (Alt. 2) demonstrated in the table 1700 shown in FIG. 17, the 8 subframes are divided into two groups with odd and even subframe indexes, and the most significant bit in the Subcarrier Indication field is used to indicate the group with the table shown in FIG. 17.

Yet in another alternative (Alt.3), a separate parameter, e.g. an offset value, can be configured instead of reusing a bit from other DCI fields. The tables in FIGS. 16 and 17 can be achieved by configuring a separate offset parameter without re-interpreting the unused bit in the subcarrier indication field. The offset parameter can be only 1 bit. The 8 subframes are divided into two groups, and the offset parameter indicates which group is used.

For the Alt.1 table in FIG. 16, the offset parameter bit indicates the groups between the first 4 subframes and the last 4 subframe in the U=8 timeslot, e.g. offset parameter bit of 0 indicates the first 4 subframes, offset parameter bit of 1 indicates the last 4 subframes. The scheduling delay indication indicates the relative index in the 4 subframes.

For the Alt.2 table in FIG. 17, the offset parameter bit indicates the groups between the odd number subframe indexes and the even number subframe indexes in the U=8 timeslot, e.g. offset parameter bit of 0 indicates the 4 subframes with even index numbers, offset parameter bit of 1 indicates the 4 subframes with odd index numbers. The scheduling delay indication indicates the relative index in the group of 4 subframes.

The eNB can divide the NB-IoT devices into different groups for more balanced and efficient scheduling.

Yet in another alternative (Alt. 4), the DCI format may be modified, or a new specific DCI format can be defined for IoT NTN TDD. In the new DCI format, the scheduling delay field has 3 bits. Thus, the scheduling delay field can indicate any subframe index in a U=8 timeslot. The bit width of other DCI fields may be reduced in the new DCI format, e.g. 5 bits are used for subcarrier indication field.

In another alternative, the full flexibility of indicating any subframe index in a U=8 timeslot may not be needed. The 2 bits scheduling delay indication can be used to indicate only an even number of subframe indexes. Thus, a NPUSCH transmission can only start from subframe indexes 0, 2, 4, 6 in a U=8 UL timeslot 334. No additional bit is needed and no re-interpretation of other DCI fields. Depending on the subcarrier indication on single tone or multiple tone transmission, the actual valid starting point may be a subset of the supported starting points. Also, since NPUSCH repetition is normally needed, the reduced starting point space will not cause a waste of resources.

Case 2: A Single NPUSCH Transmission is Confined within a UL Slot in a Period, and the Start Points are Limited Based on a Scheduled Number of Subcarriers in a Npusch

Depending on the NPUSCH resource allocation, an NPUSCH transmission may occupy multiple subframes. If a NPUSCH transmission is fully confined within the U=8 UL timeslot 334, the number of valid starting points are inversely proportional to the number of slots in the resource indication.

The delay field has only 2 bits, thus can indicate 4 different indexes as the starting point. Since NPUSCH with 3.75 SCS will occupy all UL subframes in UL slots of multiple periods, no starting position indication is necessary. In the context below, the NPUSCH format 1 548 with 15 kHz SCS is discussed for different subcarrier indications with a different number of slots for the RUs according to the tables described above.

For I_{SC} from 0-11, a RU requires 16 slots, i.e. 8 subframes. To fit the NPUSCH in the U=8 timeslot, the NPUSCH will occupy all UL subframes in the U=8 timeslot. Thus, no additional delay information is needed. The scheduling delay field should be always 00, and the NPUSCH transmission will occupy all subframes in the U=8 timeslot.

Additionally or alternatively, the unused Scheduling Delay field may indicate the number of periods if extra delay is required. For example, a Scheduling Delay field with “00” indicates the NPUSCH transmission starts in the U=8 time immediately after the scheduling DCI DL timeslot. Scheduling Delay field with “01” indicates the NPUSCH transmission starts in the U=8 timeslot of the next period, i.e. 90 ms after the UL slot in the same period. Scheduling Delay field with “10” indicates the NPUSCH transmission starts in the U=8 timeslot after two periods, i.e. 180 ms later the UL slot in the same period. Scheduling Delay field with “11” indicates the NPUSCH transmission starts in the U=8 timeslot after three periods, i.e. 270 ms after the UL slot in the same period. Alternatively, only 1 bit is used to indicate the extra period delay, e.g. Scheduling Delay field with “00” indicates the NPUSCH transmission starts in the U=8 time immediately after the scheduling DCI DL timeslot. Scheduling Delay field with “01” (or “10”) indicates the NPUSCH transmission starts in the U=8 timeslot of the next period, i.e. 90 ms after the UL slot in the same period.

For I_{SC} from 12-15, a Radio Unit (RU) requires 8 slots, i.e. 4 subframes. Two starting points can be considered with subframe index 0 and subframe index 4 respectively. Considering potential repetitions of NPUSCH, the two starting points can make sure a full NPUSCH transmission can be performed in a U=8 timeslot. If other starting points, e.g. subframe index 2 is used, the first NPUSCH can be transmitted in the U=8 timeslot, but continuous repetition may not be possible since there will not be enough subframes left in the U=8 timeslot.

Thus, only 1 bit is enough to indicate the starting positions in the U=8 timeslot. For example, the scheduling delay field of “00” indicates subframe index 0, and “01” indicates subframe 4 as starting point in the U=8 timeslot. Alternatively, the scheduling delay field of 00 indicates subframe index 0, and “10” indicates subframe 4 as the starting point in the U=8 timeslot. Yet in another alternative, “00” is used to indicate subframe index 0 and “11” is used to indicate subframe 4 as starting point in the U=8 timeslot.

Additionally or alternatively, the unused Scheduling Delay field may indicate the number of periods if extra delay is required. For example, assume the most significant bit in the Scheduling Delay field is not used, the most significant bit in the Scheduling Delay field can indicate if the NPUSCH transmission starts in the UL slot of the same period or the next period. e.g. a bit of 0 indicates the NPUSCH transmission starts in the U=8 time immediately after the scheduling DCI DL timeslot; and a bit of 1 indicates the NPUSCH transmission starts in the U=8 timeslot of the next period, i.e. 90 ms after the UL slot in the same period.

For I_{SC} from 16-17, a RU requires 4 slots, i.e. 2 subframes. Four starting points can be considered with subframe index 0, 2, 4, 6 respectively. Considering potential repetitions of NPUSCH, these starting points can make sure a full NPUSCH transmission can be performed in a U=8 timeslot, especially when repetition is performed.

Thus, the 2 bits of the scheduling delay field can be reused to indicate the starting positions in the U=8 timeslot. For example, the scheduling delay field of 00 indicates subframe index 0, 01 indicates subframe 2, 10 indicates subframe 4, and 11 indicates subframe 6 as starting point in the U=8 timeslot.

For I_{SC}=18, a RU requires 2 slots, i.e. 1 subframe. For full flexibility, 3 bits are needed to indicate any subframe as the starting point. There are 2 bits in the scheduling delay field, one additional bit should be provided from other DCI fields or a separate signaling. The methods in Case 1 can be reused here. For example, use the unused bit in subcarrier indication field together with the 2-bit scheduling delay field.

Issue 3: The Scheduling Delay k₀ Indication in DCI Format N1 for NPDSCH HARQ-ACK with NPUSCH Format 2
Issues with DCI Format N1 NPDSCH HARQ-ACK Timing Indication

In current NB-IoT FDD, The UE shall upon detection of a NPDSCH transmission ending in NB-IoT subframe n intended for the UE and for which an ACK/NACK shall be provided, start, after the end of:

$$n + {k}_{0}^{′} + {K}_{offset} - 1$$

DL subframe for FDD.

Transmission of the NPUSCH carrying ACK/NACK response, and SR (if any) if the serving cell is FDD and the UE is configured with higher layer parameter sr-with-HARQ-ACK-Config, using NPUSCH format 2 648 in N consecutive NB-IoT UL slots.

The K_{offset} is the same parameter for NPUSCH scheduling with DCI format N0. In IoT NTN TDD, K_{offset} may not be necessary since there is a big guard period 338 already between the DL timeslot 336 and UL timeslot 334. Also, a fixed K_{offset} cannot be adjusted to indicate the UL subframe index within the U=8 UL timeslot 334.

In DCI format N1, the HARQ-ACK resource field has 4 bits that are used to indicate a NPUSCH format 2 resource for HARQ-ACK feedback. The indication includes a frequency domain resource, i.e. a subcarrier index for the NPUSCH format 2 648, and a timing indication k0 for NPUSCH format 2 648. The number of bits for the subcarrier indication and timing indication are different for different SCS settings. The k0 value can only be selected from a fixed set of selected values.

For 3.75 kHz SCS (as shown in FIG. 12), 3 bits are used for NPUSCH subcarrier ACK/NACK resource indication, and 1 bit for k0. The k0 can be either 13 or 21.

For 15 kHz SCS (as shown in FIG. 13), 2 bits are used for NPUSCH subcarrier ACK/NACK resource indication, and 2 bits for k0. The k0 can be selected from 13, 15, 17, 18.

For scheduling flexibility with limited UL subframes in a period, the eNB should be able to schedule HARQ-ACK reporting in any subframe index in the U=8 timeslot. A fixed K_{offset} value combined with k0 is still not sufficient. For example, to schedule the same HARQ-ACK timing in a U=8 timeslot, the distances from different DL subframes in the D=8 timeslot are different. Thus, the K_{offset} value should be different depending on the position of the DL subframe carrying the scheduling DCI in the D=8 timeslot.

In IoT NTN TDD, if the k0 is maintained as the distance from the NPDSCH to the HARQ-ACK on a NPUSCH format 2 transmission, the indicated subframes are most likely not in the U=8 uplink slot since there is only a single U=8 UL timeslot 334 in a period of 90 ms, and the valid k0 values are much smaller than the guard period 338 of approximately 50 ms.

If k0 is interpreted based on the available or valid uplink subframe in the U=8 timeslots only as in NB-IoT TDD case, the different k0 values will lead to long delays into multiple periods. Additionally, the k0 cannot indicate some subframe indexes within the U=8 UL timeslot 334 since the k0 value is selected from a list of fixed values.

As shown in FIG. 4, some DL subframes are already occupied with synchronization signals, the remaining subframe may be used for NPDCCH and NPDSCH. With limited subframes for NPDSCH transmissions, with existing Koffset and k0 indication, the subframes that can be indicated for HARQ-ACK feedback in the UL timeslot 334 will also be limited.

Furthermore, the NPUSCH normally occupies multiple slots and subframes, the limited number of starting positions in a U=8 UL subframe timeslot will lead to segmented NPUSCH transmissions if the remaining number of slots is not enough for the scheduled NPUSCH transmission. This will cause more specification impact and performance degradation.

HARQ-ACK Resource Indication for NPUSCH Format 2 Position within U=8 Timeslot

NPUSCH format 2 648 is mapped as per current specifications. With only one UL timeslot 334 in a period, NPUSCH should be scheduled within the U=8 timeslot with any slot starting positions. Since the number of slots for an NPUSCH is at least two, a subframe index within the U=8 timeslot is enough.

The DL to UL guard period 338 is already around 50 ms without considering the subframe indexes in the D=8 timeslot and U=8 timeslot. The total delay is much higher than the maximum k0 value (21 ms for 3.75 kHz and 18 ms for 15 kHz) in the HARQ-ACK resource indication already. The next available U=8 timeslot will be 90 ms later based on the periodicity.

Thus, to minimize the HARQ-ACK feedback delay, the NPUSCH format 2 transmission may always start in the next U=8 timeslot after the D=8 slot that carries the NPDSCH transmission. Since the guard period 338 is fixed for IoT NTN TDD subframe structure, the HARQ-ACK timing k0 indication part can be reused to indicate the subframe index within the U=8 timeslot for HARQ-ACK reporting on NPUSCH format 2 648.

As shown in the table 700 of FIG. 7, for a NPUSCH format 2 RU requires 4 slots. Both 3.75 kHz SCS and 15 kHz SCS may be used for NPUSCH format 2 648.

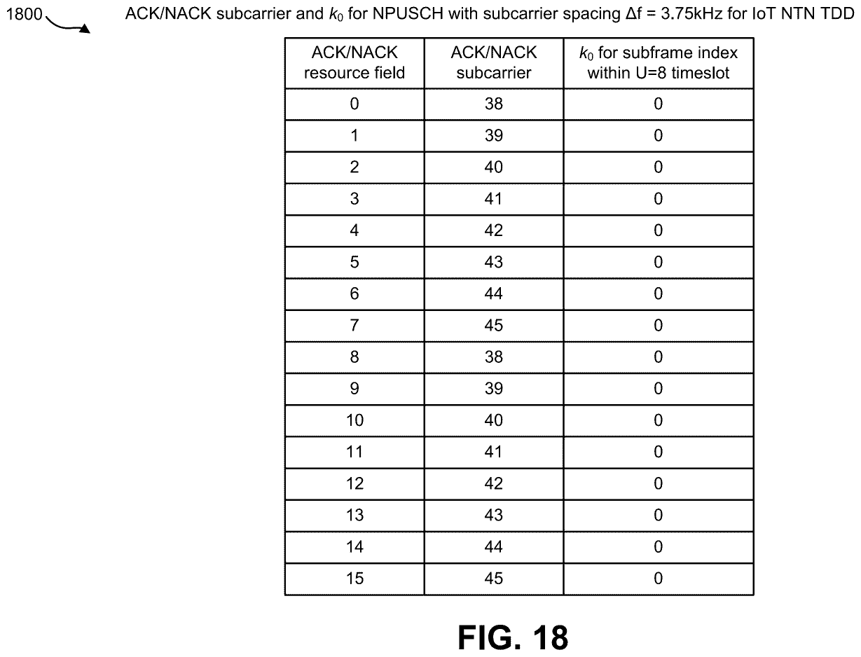

In case of 3.75 kHz SCS, each slot is 2 ms. Thus, a NPUSCH format 2 transmission occupies 4 slots, i.e. all subframes in a U=8 UL subframe timeslot. So the NPUSCH format 2 648 should start from subframe 0 in the U=8 timeslot, and no other starting point is needed or valid. Therefore, for the HACK-ACK resource field for 3.75 kHz SCS, 3 bits on the ACK/NACK subcarrier can be used as it is, and the 1 bit for k0 may not be used as set as 0, as shown in FIG. 18, which is a table 1800 showing an example of ACK/NACK subcarrier and for NPUSCH with subcarrier spacing for IoT NTN TDD.

Additionally or alternatively, the unused bit for k0 may indicate the number of periods if extra delay is required. For example, a bit of 0 indicates the NPUSCH format 2 transmission starts in the U=8 time immediately after the NPDSCH transmission in a DL timeslot 336; and a bit of 1 indicates the NPUSCH format 2 transmission starts in the U=8 timeslot of the next period, i.e. 90 ms after the UL slot in the same period.

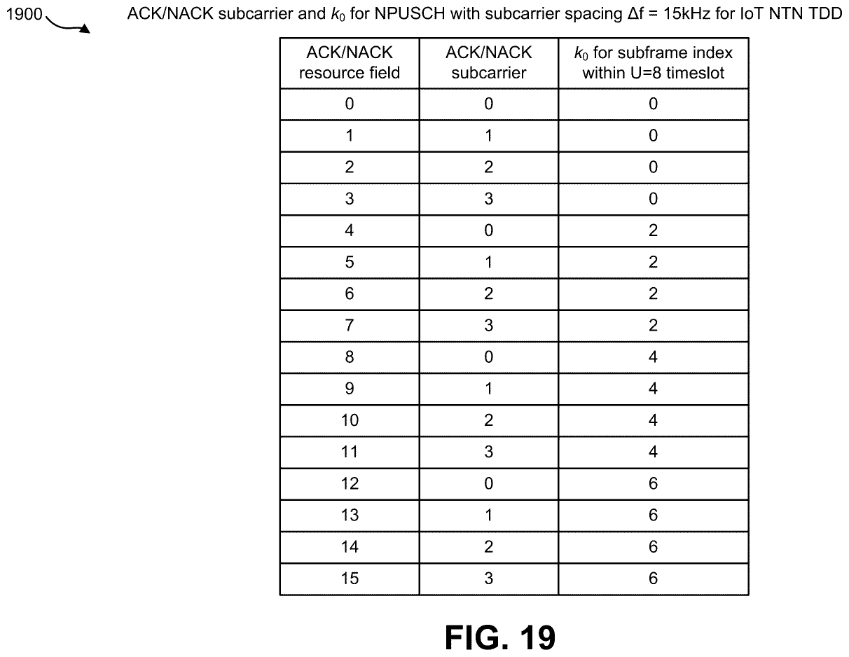

FIG. 19 is a table 1900 showing an example of ACK/NACK subcarrier and for NPUSCH with subcarrier spacing for IoT NTN TDD.

In case of 15 kHz SCS, each slot is 0.5 ms. Thus, a NPUSCH format 2 transmission occupies 4 slots, i.e. 2 ms, in a U=8 UL timeslot 334. So the NPUSCH format 2 648 may have 4 different starting points with subframe indexes 0, 2, 4, 6 respectively in a U=8 timeslot. Therefore, for the HACK-ACK resource field for 15 kHz SCS, 2 bits on the ACK/NACK subcarrier can be used as it is, and the 2 bits for k0 may be reused to indicate the starting subframe index for the NPUSCH format 2 transmission, as shown in the table below. For example, the two most significant bits of 00 indicates k0=0, the NPUSCH starts from subframe index 0 within the U=8 timeslot; the two most significant bits of 01 indicates k0-2, the NPUSCH starts from subframe index 2 within the U=8 timeslot; and so on.

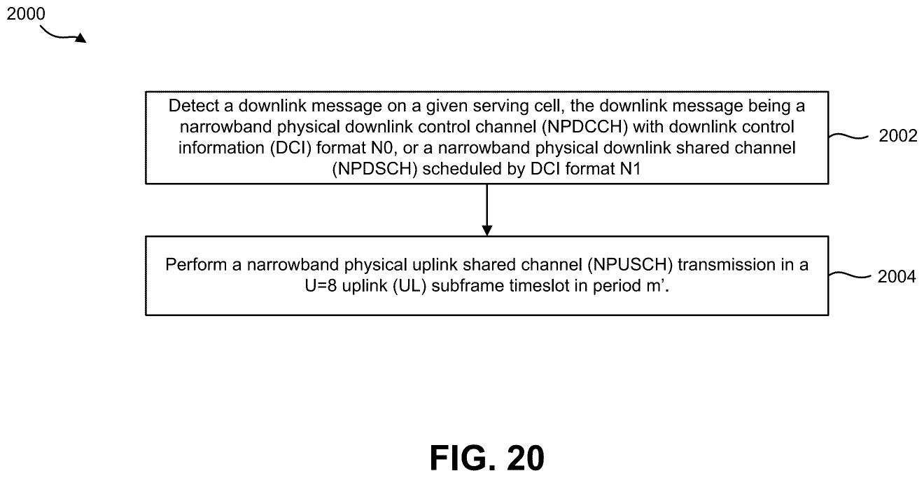

FIG. 20 is a flow diagram illustrating a method 2000 by a UE configured for operation in an IoT NTN using TDD. The UE may detect 2002 a downlink message on a given serving cell, the downlink message being a narrowband physical downlink control channel (NPDCCH) with downlink control information (DCI) format N0, or a narrowband physical downlink shared channel (NPDSCH) scheduled by DCI format N1. The UE may also perform 2004 a narrowband physical uplink shared channel (NPUSCH) transmission in a U=8 uplink (UL) subframe timeslot in period m′.

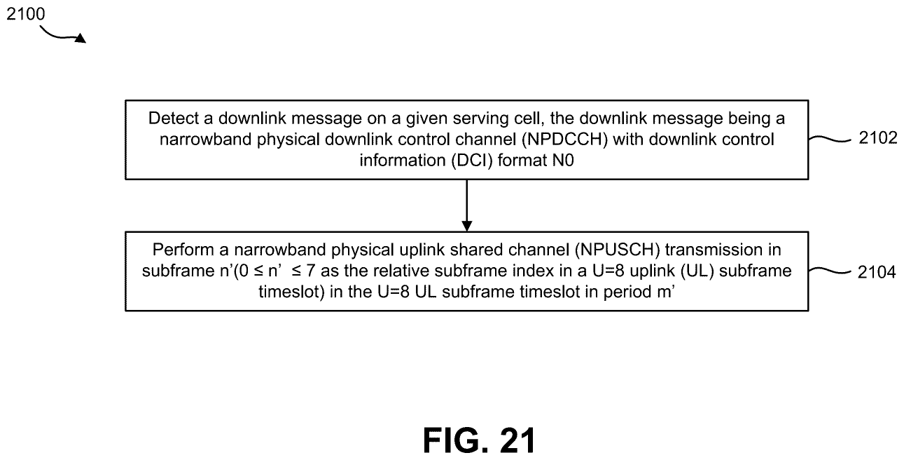

FIG. 21 is a flow diagram illustrating another method 2100 by a UE configured for operation in an IoT NTN using TDD. The UE may detect 2102 a downlink message on a given serving cell, the downlink message being a narrowband physical downlink control channel (NPDCCH) with downlink control information (DCI) format N0. The UE may also perform 2104 a narrowband physical uplink shared channel (NPUSCH) transmission in subframe n′ (0≤n′≤7 as the relative subframe index in a U=8 uplink (UL) subframe timeslot) in the U=8 UL subframe timeslot in period m′.

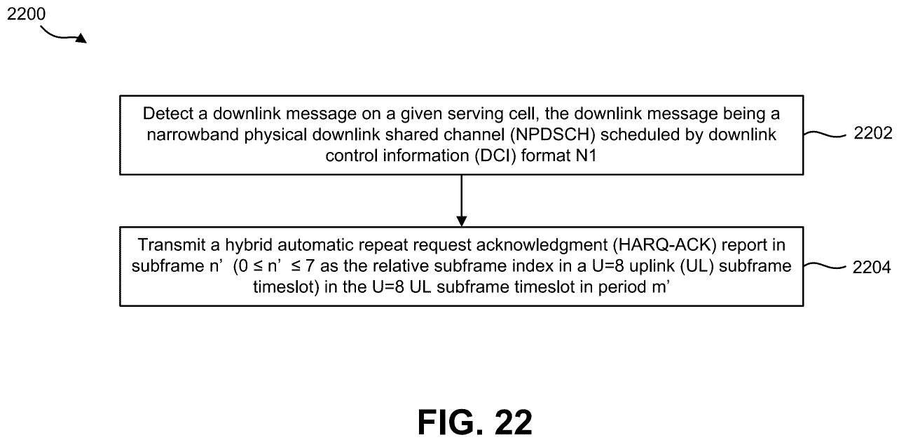

FIG. 22 is a flow diagram illustrating another method 2200 by a UE configured for operation in an IoT NTN using TDD. The UE may detect 2202 a downlink message on a given serving cell, the downlink message being a narrowband physical downlink shared channel (NPDSCH) scheduled by downlink control information (DCI) format N1. The UE may also transmit 2204 a hybrid automatic repeat request acknowledgment (HARQ-ACK) report in subframe n′ (0≤n′≤7 as the relative subframe index in a U=8 uplink (UL) subframe timeslot) in the U=8 UL subframe timeslot in period m′.

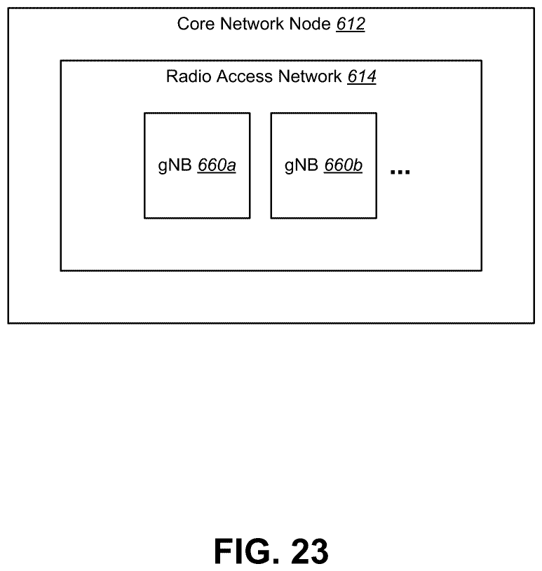

FIG. 23 is block diagram illustrating one implementation of a core network node 612. The core network node 612 may include a radio access network 614 that includes a plurality of gNBs (gNB 660a, 660b). Messages transmitted and received by the core network node 612 may be transmitted and received by the gNBs 660a, 660b in the radio access network 614. The core network node 612 may be part of the 5GC 118 or the NG-RAN 102.

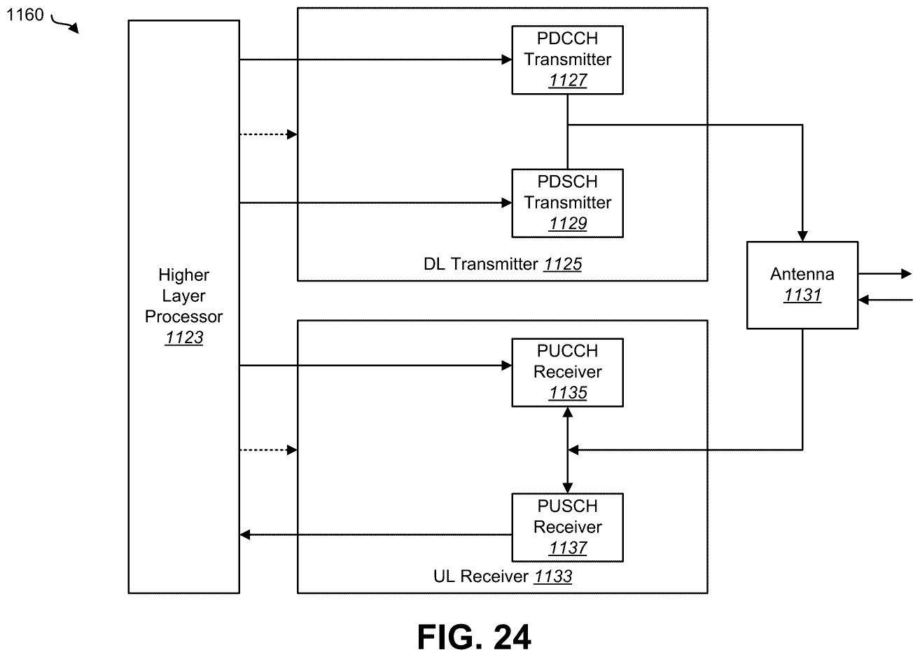

FIG. 24 is a block diagram illustrating one implementation of a eNB 1160. The eNB 1160 may include a higher layer processor 1123, a DL transmitter 1125, a UL receiver 1133, and one or more antenna 1131. The DL transmitter 1125 may include a PDCCH transmitter 1127 and a PDSCH transmitter 1129. The UL receiver 1133 may include a PUCCH receiver 1135 and a PUSCH receiver 1137.

The higher layer processor 1123 may manage physical layer's behaviors (the DL transmitter's and the UL receiver's behaviors) and provide higher layer parameters to the physical layer. The higher layer processor 1123 may obtain transport blocks from the physical layer. The higher layer processor 1123 may send and/or acquire higher layer messages such as an RRC message and MAC message to and/or from a wireless terminal's higher layer. The higher layer processor 1123 may provide the PDSCH transmitter transport blocks and provide the PDCCH transmitter transmission parameters related to the transport blocks.

The DL transmitter 1125 may multiplex downlink physical channels and downlink physical signals (including reservation signal) and transmit them via transmission antennas 1131. The UL receiver 1133 may receive multiplexed uplink physical channels and uplink physical signals via receiving antennas 1131 and de-multiplex them. The PUCCH receiver 1135 may provide the higher layer processor 1123 Uplink Control Information (UCI). The PUSCH receiver 1137 may provide the higher layer processor 1123 received transport blocks.

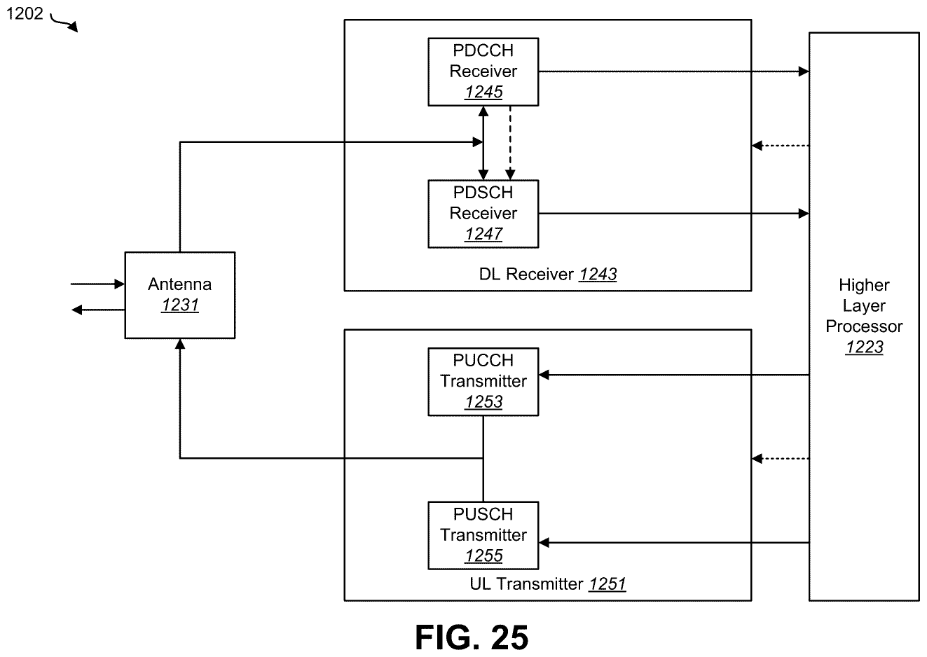

FIG. 25 is a block diagram illustrating one implementation of a wireless terminal 1202. In some examples, the wireless terminal 1202 is a UE. The wireless terminal 1202 may include a higher layer processor 1223, a UL transmitter 1251, a DL receiver 1243, and one or more antenna 1231. The UL transmitter 1251 may include a PUCCH transmitter 1253 and a PUSCH transmitter 1255. The DL receiver 1243 may include a PDCCH receiver 1245 and a PDSCH receiver 1247.

The higher layer processor 1223 may manage physical layer's behaviors (the UL transmitter's and the DL receiver's behaviors) and provide higher layer parameters to the physical layer. The higher layer processor 1223 may obtain transport blocks from the physical layer. The higher layer processor 1223 may send and/or acquire higher layer messages such as an RRC message and MAC message to and/or from a wireless terminal's higher layer. The higher layer processor 1223 may provide the PUSCH transmitter transport blocks and provide the PUCCH transmitter 1253 UCI.

The DL receiver 1243 may receive multiplexed downlink physical channels and downlink physical signals via receiving antennas 1231 and de-multiplex them. The PDCCH receiver 1245 may provide the higher layer processor 1223 DCI (Downlink Control Information). The PDSCH receiver 1247 may provide the higher layer processor 1223 received transport blocks.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

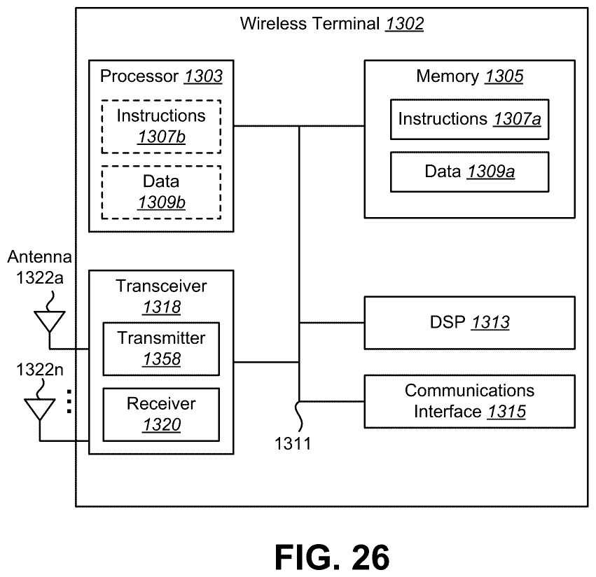

FIG. 26 illustrates various components that may be utilized in a wireless terminal 1302. In some examples, the wireless terminal 1302 is a UE. The wireless terminal 1302 described in connection with FIG. 35 may be implemented in accordance with the wireless terminal described herein. The wireless terminal 1302 includes a processor 1303 that controls operation of the wireless terminal 1302. The processor 1303 may also be referred to as a central processing unit (CPU). Memory 1305, which may include read-only memory (ROM), random access memory (RAM), a combination of the two or any type of device that may store information, provides instructions 1307a and data 1309a to the processor 1303. A portion of the memory 1305 may also include non-volatile random-access memory (NVRAM). Instructions 1307b and data 1309b may also reside in the processor 1303. Instructions 1307b and/or data 1309b loaded into the processor 1303 may also include instructions 1307a and/or data 1309a from memory 1305 that were loaded for execution or processing by the processor 1303. The instructions 1307b may be executed by the processor 1303 to implement the methods described above.

The wireless terminal 1302 may also include a housing that contains one or more transmitters 1358 and one or more receivers 1320 to allow transmission and reception of data. The transmitter(s) 1358 and receiver(s) 1320 may be combined into one or more transceivers 1318. One or more antennas 1322a-n are attached to the housing and electrically coupled to the transceiver 1318.

The various components of the wireless terminal 1302 are coupled together by a bus system 1311, which may include a power bus, a control signal bus and a status signal bus, in addition to a data bus. However, for the sake of clarity, the various buses are illustrated in FIG. 35 as the bus system 1311. The wireless terminal 1302 may also include a digital signal processor (DSP) 1313 for use in processing signals. The wireless terminal 1302 may also include a communications interface 1315 that provides user access to the functions of the wireless terminal 1302. The wireless terminal 1302 illustrated in FIG. 35 is a functional block diagram rather than a listing of specific components.

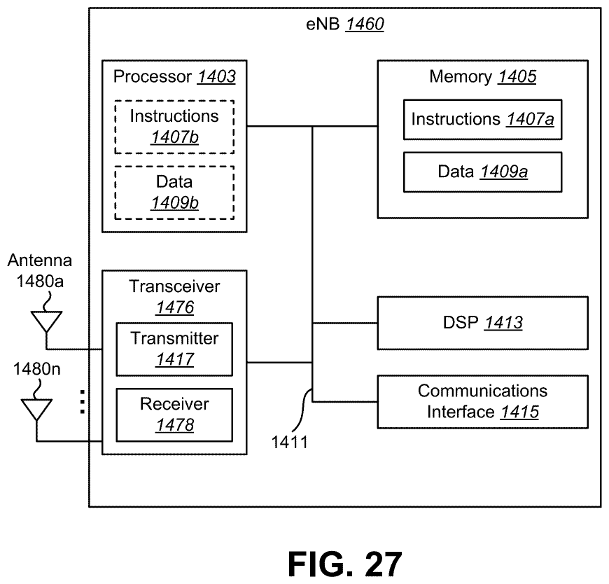

FIG. 27 illustrates various components that may be utilized in a eNB 1460. The eNB 1460 described in connection with FIG. 35 may be implemented in accordance with the eNB described herein. The eNB 1460 includes a processor 1403 that controls operation of the eNB 1460. The processor 1403 may also be referred to as a central processing unit (CPU). Memory 1405, which may include read-only memory (ROM), random access memory (RAM), a combination of the two or any type of device that may store information, provides instructions 1407a and data 1409a to the processor 1403. A portion of the memory 1405 may also include non-volatile random-access memory (NVRAM). Instructions 1407b and data 1409b may also reside in the processor 1403. Instructions 1407b and/or data 1409b loaded into the processor 1403 may also include instructions 1407a and/or data 1409a from memory 1405 that were loaded for execution or processing by the processor 1403. The instructions 1407b may be executed by the processor 1403 to implement the methods described above.

The eNB 1460 may also include a housing that contains one or more transmitters 1417 and one or more receivers 1478 to allow transmission and reception of data. The transmitter(s) 1417 and receiver(s) 1478 may be combined into one or more transceivers 1476. One or more antennas 1480a-n are attached to the housing and electrically coupled to the transceiver 1476.

The various components of the eNB 1460 are coupled together by a bus system 1411, which may include a power bus, a control signal bus and a status signal bus, in addition to a data bus. However, for the sake of clarity, the various buses are illustrated in FIG. 36 as the bus system 1411. The eNB 1460 may also include a digital signal processor (DSP) 1413 for use in processing signals. The eNB 1460 may also include a communications interface 1415 that provides user access to the functions of the eNB 1460. The eNB 1460 illustrated in FIG. 36 is a functional block diagram rather than a listing of specific components.

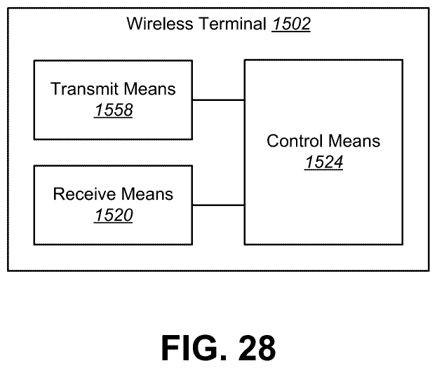

FIG. 28 is a block diagram illustrating one implementation of a wireless terminal 1502 in which systems and methods for resource allocations of enhanced uplink transmissions may be implemented. The wireless terminal 1502 includes transmit means 1558, receive means 1520 and control means 1524. The transmit means 1558, receive means 1520 and control means 1524 may be configured to perform one or more of the functions described herein. FIG. 35 above illustrates one example of a concrete apparatus structure of FIG. 37. Other various structures may be implemented to realize one or more of the functions herein. For example, a DSP may be realized by software.

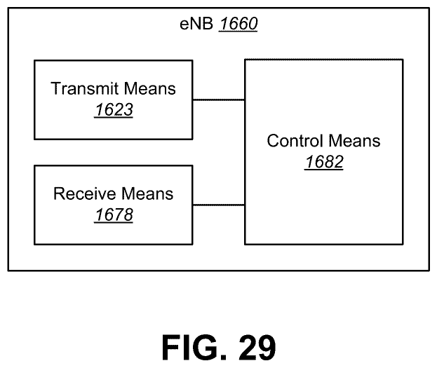

FIG. 29 is a block diagram illustrating one implementation of a eNB 1660 in which systems and methods for resource allocations of enhanced uplink transmissions may be implemented. The eNB 1660 includes transmit means 1623, receive means 1678, and control means 1682. The transmit means 1623, receive means 1678, and control means 1682 may be configured to perform one or more of the functions described herein. FIG. 36 above illustrates one example of a concrete apparatus structure of FIG. 38. Other various structures may be implemented to realize one or more of the functions described herein. For example, a DSP may be realized by software.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes, and variations may be made in the arrangement, operation, and details of the systems, methods, and apparatus described herein without departing from the scope of the claims.

A program running on the gNB or the wireless terminal according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or Hard Disk Drives (HDDs), and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB and the wireless terminal according to the systems and methods described above may be realized as an LSI that is a typical integrated circuit. Each functional block of the gNB and the wireless terminal may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned implementations may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

1. A user equipment (UE) configured for operation in an internet of things (IoT) non-terrestrial network (NTN) using time division duplex (TDD), comprising:
receiving circuitry configured to:
detect a downlink message on a given serving cell, the downlink message being a narrowband physical downlink control channel (NPDCCH) with downlink control information (DCI) format N0, or a narrowband physical downlink shared channel (NPDSCH) scheduled by DCI format N1; and
transmitting circuitry configured to:
perform a narrowband physical uplink shared channel (NPUSCH) transmission in a U=8 uplink (UL) subframe timeslot in period m′.

2. The UE of claim 1, wherein the downlink message ends in narrowband internet of things (NB-IoT) downlink (DL) subframe index n (0≤n≤7) within a D=8 DL subframe timeslot in period m.

3. The UE of claim 2, wherein the downlink message schedules a narrowband physical uplink shared channel (NPUSCH) format 1 transmission or a hybrid automatic repeat request acknowledgment (HARQ-ACK) report with NPUSCH format 2 intended for the UE.

4. The UE of claim 1, wherein m′=m+Koffset when Koffset is configured with a positive integer number.

5. The UE of claim 1, wherein m′=m when Koffset is not configured or set as 0.

6. An e-NodeB (eNB) configured for operation in an internet of things (IoT) non-terrestrial network (NTN) using time division duplex (TDD), comprising:
transmitting circuitry configured to:
transmit a downlink message on a given serving cell, the downlink message being a narrowband physical downlink control channel (NPDCCH) with downlink control information (DCI) format N0, or a narrowband physical downlink shared channel (NPDSCH) scheduled by DCI format N1; and
receiving circuitry configured to:
receive a narrowband physical uplink shared channel (NPUSCH) transmission in a U=8 uplink (UL) subframe timeslot in period m′.

7. The eNB of claim 6, wherein the downlink message ends in narrowband internet of things (NB-IoT) downlink (DL) subframe index n (0≤n≤7) within a D=8 DL subframe timeslot in period m.

8. The eNB of claim 7, wherein the downlink message schedules a narrowband physical uplink shared channel (NPUSCH) format 1 transmission or a hybrid automatic repeat request acknowledgment (HARQ-ACK) report with NPUSCH format 2 intended for the UE.

9. The eNB of claim 6, wherein the transmitting circuitry is further configured to configure a Koffset parameter via radio resource control (RRC) signaling.

10. The eNB of claim 9, wherein the K_{offset} parameter is used to determine the scheduling delay in a number of IoT NTN TDD periods, wherein each period is 90 milliseconds (ms).

11. The eNB of claim 9, wherein m′=m+Koffset when the K_{offset} parameter is configured with a positive integer number.

12. The eNB of claim 6, wherein m′=m when a Koffset parameter is not configured or set as 0.

13. A method performed by a user equipment (UE) configured for operation in an internet of things (IoT) non-terrestrial network (NTN) using time division duplex (TDD), comprising:
detecting a downlink message on a given serving cell, the downlink message being a narrowband physical downlink control channel (NPDCCH) with downlink control information (DCI) format N0, or a narrowband physical downlink shared channel (NPDSCH) scheduled by DCI format N1; and
performing a narrowband physical uplink shared channel (NPUSCH) transmission in a U=8 uplink (UL) subframe timeslot in period m′.
